(19) United States
(12) Patent Application Publication
(10) Pub. No.: US 2025/0180727 A1
(43) Pub. Date: Jun. 5, 2025

(54) SYSTEMS AND METHODS FOR IDENTIFYING WAVEFORM FREQUENCY SIGNATURE USING TIMESTAMPS

(71) Applicant: COGNITIVE SYSTEMS CORP., Waterloo (CA)

(72) Inventors: Chris BEG, Waterloo, Ontario (CA); Mohammad OMER, Waterloo, Ontario (CA)

(21) Appl. No.: 18/844,307

(22) PCT Filed: Mar. 8, 2023
(86) PCT No.: PCT/IB2023/052216

§ 371 Date: Sep. 5, 2024

Related U.S. Application Data
(60) Provisional application No. 63/325,224, filed on Mar. 30, 2022.
(60) Provisional application No. 63/318,999, filed on Mar. 11, 2022.

(51) Int. Cl. G01S 13/56; G01S 13/00; G01S 13/62

(52) U.S. Cl. CPC G01S 13/56; G01S 13/003; G01S 13/62

(57) ABSTRACT

A method is described for Wi-Fi sensing. The method is carried out by a networked device operating as a sensing receiver. The networked device includes at least one processor configured to execute instructions. Initially, a series of time domain pulse sets determined from a series of sensing measurements based on a series of sensing transmissions transmitted by a sensing transmitter and received by the networked device over a time interval is obtained. Thereafter, a signature pulse occurring in the time domain pulse sets is identified. A series of amplitudes of the signature pulse in the time domain pulse sets are recorded. Further, a waveform frequency signature of a small motion occurring in a sensing space corresponding with the networked device is identified based on the series of amplitudes of the signature pulse.

### TECHNICAL FIELD

The present disclosure generally relates to systems and methods for Wi-Fi sensing. In particular, the present disclosure relates to systems and methods for identifying waveform frequency signature using timestamps.

### BACKGROUND OF THE DISCLOSURE

Motion detection systems have often been used to detect movement in an environment, for example, objects in a room or an outdoor area. A Wi-Fi sensing system is one recent addition to motion detection systems. The Wi-Fi sensing system may be a network of Wi-Fi-enabled devices that may be a part of an IEEE 802.11 network. For example, the Wi-Fi sensing system may include a sensing receiver and a sensing transmitter. In an example, the Wi-Fi sensing system may be configured to detect features of interest in a sensing space. The sensing space may refer to any physical space in which the Wi-Fi sensing system may operate, such as a place of residence, a place of work, a shopping mall, a sports hall or sports stadium, a garden, or any other physical space. The features of interest may include motion of objects and motion tracking, presence detection, intrusion detection, gesture recognition, fall detection, breathing rate detection, among other applications. Features of interest may also be referred to as physical processes.

### BRIEF SUMMARY OF THE DISCLOSURE

The present disclosure generally relates to systems and methods for Wi-Fi sensing. In particular, the present disclosure relates to systems and methods for identifying waveform frequency signature using timestamps.

Systems and methods are provided for Wi-Fi sensing. In an example embodiment, a method for Wi-Fi sensing carried out by a networked device operating as a sensing receiver is described. The networked device includes at least one processor configured to execute instructions. The method includes obtaining a series of time domain pulse sets determined from a series of sensing measurements based on a series of sensing transmissions transmitted by a sensing transmitter and received by the networked device over a time interval, identifying a signature pulse occurring in the time domain pulse sets, recording a series of amplitudes of the signature pulse in the time domain pulse sets, and identifying a waveform frequency signature of a small motion occurring in a sensing space corresponding with the networked device based on the series of amplitudes of the signature pulse.

In some embodiments, the signature pulse represents a plurality of corresponding pulses, each of the corresponding pulses occurring in a respective one of the time domain pulse sets.

In some embodiments, identifying the signature pulse includes selecting the signature pulse from among a plurality of bobbing pulses displaying amplitude variations in the time domain pulse sets.

In some embodiments, identifying the signature pulse includes selecting the bobbing pulse having a largest amplitude variation from among the plurality of bobbing pulses.

In some embodiments, the series of amplitudes of the signature pulse has a uniform timing between amplitudes.

In some embodiments, the series of amplitudes of the signature pulse has a non-uniform timing between amplitudes.

In some embodiments, timing between amplitudes of the series of amplitudes is based on timing of at least one of the sensing transmissions and the sensing measurements.

In some embodiments, recording the series of amplitudes of the signature pulse includes recording variations in amplitude of the signature pulse.

In some embodiments, identifying the waveform frequency signature includes evaluating the series of amplitudes of the signature pulse relative to a reasonable frequency waveform.

In some embodiments, evaluating the series of amplitudes of the signature pulse relative to a reasonable frequency waveform includes creating a Fourier basis function from the series of amplitudes of the signature pulse and the reasonable frequency waveform.

In some embodiments, the sensing space further corresponds to the transmission pathway between the networked device and the sensing transmitter.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system;

FIG. 2A and FIG. 2B are diagrams showing example wireless signals communicated between wireless communication devices;

FIG. 3A and FIG. 3B are plots showing examples of channel responses computed from the wireless signals communicated between wireless communication devices in FIG. 2A and FIG. 2B;

FIG. 4A and FIG. 4B are diagrams showing example channel responses associated with motion of an object in distinct regions of a space;

FIG. 4C and FIG. 4D are plots showing the example channel responses of FIG. 4A and FIG. 4B overlaid on an example channel response associated with no motion occurring in the space;

FIG. 5 depicts some of an architecture of an implementation of a system for Wi-Fi sensing, according to some embodiments;

FIG. 6 illustrates a management frame carrying a sensing transmission, according to some embodiments;

FIG. 7A illustrates an example of a format of a control frame and FIG. 7B illustrates a format of a sensing transmission announcement control field of the control frame, according to some embodiments;

FIG. 8A illustrates another example of a format of a control frame and FIG. 8B illustrates a format of a sensing measurement control field of the control frame, according to some embodiments;

FIG. 9 illustrates a management frame carrying a CRI transmission message, according to some embodiments;

FIG. 10 depicts an example representation of a transmission channel, which includes a direct signal path and a single multipath, according to some embodiments;

FIG. 11 depicts an example representation of amplitude and time of multipath time domain pulses, according to some embodiments;

FIG. 12 depicts an example representation of an amplitude of a received multipath signal with a single reflected time domain pulse changed or modulated by a small motion of an object, according to some embodiments;

FIG. 13 depicts an example representation of a small motion with a waveform frequency signature, according to some embodiments;

FIG. 14 depicts an example representation of amplitudes of received time domain pulses including a signature pulse, according to some embodiments;

FIG. 15A, FIG. 15B, and FIG. 15C depict example representations of amplitudes of received time domain pulses including a signature pulse at different sensing measurement times, according to some embodiments;

FIG. 16 depicts an example representation of series of amplitudes of a signature pulse, according to some embodiments;

FIG. 17A depicts an example of a reasonable frequency that is well aligned with a frequency of a waveform amplitude variation of a signature pulse, according to some embodiments;

FIG. 17B depicts an example of a reasonable frequency that is not well aligned with a frequency of a waveform amplitude variation of a signature pulse, according to some embodiments; and

FIG. 18 depicts a flowchart for identification of a waveform frequency signature of a small motion occurring in a sensing space, according to some embodiments.

### DETAILED DESCRIPTION

In some aspects of what is described herein, a wireless sensing system may be used for a variety of wireless sensing applications by processing wireless signals (e.g., radio frequency (RF) signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections, and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi access point (AP) assumes the receiver role, and each Wi-Fi device (station (STA), node, or peer) connected to the AP assumes the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information, etc.) provided by a beamforming system. Beamforming is a signal processing technique often used in multi-antenna (multiple-input/multiple-output (MIMO)) radio systems for directional signal transmission or reception. Beamforming can be achieved by operating elements in an antenna array in such a way that signals at some angles experience constructive interference while others experience destructive interference.

The channel information for each of the communication links may be analyzed (e.g., by a hub device or other device in a wireless communication network, or a sensing transmitter, sensing receiver, or sensing initiator communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered or caused to make sensing transmissions or sensing measurements less frequently. In some implementations, when motion is present, for example, the wireless sensing system can increase the triggering rate or sensing transmission rate or sensing measurement rate to produce a time-series of measurements with finer time resolution. Controlling the variable sensing measurement rate can allow energy conservation (through the device triggering), reduce processing (less data to correlate or filter), and improve resolution during specified times.

In some cases, a wireless sensing system can perform band steering or client steering of nodes throughout a wireless network, for example, in a Wi-Fi multi-AP or extended service set (ESS) topology, multiple coordinating wireless APs each provide a basic service set (BSS) which may occupy different frequency bands and allow devices to transparently move between from one participating AP to another (e.g., mesh). For instance, within a home mesh network, Wi-Fi devices can connect to any of the APs, but typically select one with good signal strength. The coverage footprint of the mesh APs typically overlap, often putting each device within communication range or more than one AP. If the AP supports multi-bands (e.g., 2.4 GHz and 5 GHz), the wireless sensing system may keep a device connected to the same physical AP but instruct it to use a different frequency band to obtain more diverse information to help improve the accuracy or results of the wireless sensing algorithm (e.g., motion detection algorithm). In some implementations, the wireless sensing system can change a device from being connected to one mesh AP to being connected to another mesh AP. Such device steering can be performed, for example, during wireless sensing (e.g., motion detection), based on criteria detected in a specific area to improve detection coverage, or to better localize motion within an area.

In some cases, beamforming may be performed between wireless communication devices based on some knowledge of the communication channel (e.g., through feedback properties generated by a receiver), which can be used to generate one or more steering properties (e.g., a steering matrix) that are applied by a transmitter device to shape the transmitted beam/signal in a particular direction or directions. Thus, changes to the steering or feedback properties used in the beamforming process indicate changes, which may be caused by moving objects, in the space accessed by the wireless communication system. For example, a motion may be detected by substantial changes in the communication channel, e.g., as indicated by a channel response, or steering or feedback properties, or any combination thereof, over a period of time.

In some implementations, for example, a steering matrix may be generated at a transmitter device (beamformer) based on a feedback matrix provided by a receiver device (beamformee) based on channel sounding. Because the steering and feedback matrices are related to propagation characteristics of the channel, these matrices change as objects move within the channel. Changes in the channel characteristics are accordingly reflected in these matrices, and by analyzing the matrices, motion can be detected, and different characteristics of the detected motion can be determined. In some implementations, a spatial map may be generated based on one or more beamforming matrices. The spatial map may indicate a general direction of an object in a space relative to a wireless communication device. In some cases, many beamforming matrices (e.g., feedback matrices or steering matrices) may be generated to represent a multitude of directions that an object may be located relative to a wireless communication device. These many beamforming matrices may be used to generate the spatial map. The spatial map may be used to detect the presence of motion in the space or to detect a location of the detected motion.

In some instances, a motion detection system can control a variable device measurement rate in a motion detection process. For example, a feedback control system for a multi-node wireless motion detection system may adaptively change the sample rate based on the environment conditions. In some cases, such controls can improve operation of the motion detection system or provide other technical advantages. For example, the measurement rate may be controlled in a manner that optimizes or otherwise improves air-time usage versus detection ability suitable for a wide range of different environments and different motion detection applications. The measurement rate may be controlled in a manner that reduces redundant measurement data to be processed, thereby reducing processor load/power requirements. In some cases, the measurement rate is controlled in a manner that is adaptive, for instance, an adaptive sample can be controlled individually for each participating device. An adaptive sample rate can be used with a tuning control loop for different use cases, or device characteristics.

In some cases, a wireless sensing system can allow devices to dynamically indicate and communicate their wireless sensing capability or wireless sensing willingness to the wireless sensing system. For example, there may be times when a device does not want to be periodically interrupted or triggered to transmit a wireless signal that would allow the AP to produce a channel measurement. For instance, if a device is sleeping, frequently waking the device up to transmit or receive wireless sensing signals could consume resources (e.g., causing a cell phone battery to discharge faster). These and other events could make a device willing or not willing to participate in wireless sensing system operations. In some cases, a cell phone running on its battery may not want to participate, but when the cell phone is plugged into the charger, it may be willing to participate. Accordingly, if the cell phone is unplugged, it may indicate to the wireless sensing system to exclude the cell phone from participating; whereas if the cell phone is plugged in, it may indicate to the wireless sensing system to include the cell phone in wireless sensing system operations. In some cases, if a device is under load (e.g., a device streaming audio or video) or busy performing a primary function, the device may not want to participate; whereas when the same device's load is reduced and participating will not interfere with a primary function, the device may indicate to the wireless sensing system that it is willing to participate.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications). However, the operation, system improvements, and technical advantages achieved when the wireless sensing system is operating as a motion detection system are also applicable in examples where the wireless sensing system is used for another type of wireless sensing application.

In various embodiments of the disclosure, non-limiting definitions of one or more terms that will be used in the document are provided below.

A term “measurement campaign” may refer to a bi-directional series of one or more sensing transmissions between a sensing receiver and a sensing transmitter that allows a series of one or more sensing measurements to be computed.

A term “sensing transmitter” may refer to a device that sends transmissions (for example, NDPs and PPDUs or any other transmissions) used for sensing measurements (for example, channel state information) in a wireless local area network (WLAN) sensing session. In an embodiment, the role of the sensing transmitter may be taken by a remote device.

A term “sensing receiver” may refer to a device that receives transmissions (for example, NDPs and PPDUs or any other transmissions which may be opportunistically used for sensing measurements) sent by a sensing transmitter and performs one or more sensing measurements (for example, channel state information) in a WLAN sensing session. In an embodiment, the role of the sensing receiver may be taken by a sensing device.

A term “waveform amplitude variation” of a time domain pulse may refer to a variation on top of a base amplitude of a received reflected time domain pulse at the sensing receiver. In an implementation, the waveform amplitude variation may be caused by a periodic motion of an object in the propagation path of the received reflected time domain pulse from the sensing transmitter to the sensing receiver.

A term “steady state channel” may refer to a transmission channel resulting in a multipath signal where objects in a sensing space causing reflections in the transmission channel are relatively stationary and the reflections have stable amplitude and time delay. An example of a sensing space that results in a steady state channel may be a living room with furniture at various places in the living room.

A term “pseudo steady state channel” may refer to a transmission channel resulting in a multipath signal where objects in a sensing space causing reflections in the transmission channel are stationary for a long enough period that a base amplitude of each time domain pulse may be determined. An example of a sensing space that results in a pseudo steady state channel may be a bedroom where a person is in bed and sleeping.

A term “base amplitude” of a time domain pulse may be an amplitude of the time domain pulse in a steady state channel or pseudo steady state channel.

A term “channel state information” may refer to properties of a communications channel that are known or measured by a technique of channel estimation. Channel state information may represent how wireless signals propagate from a transmitter (for example, a sensing transmitter) to a receiver (for example, a sensing receiver) along multiple paths. Channel state information is typically a matrix of complex values representing the amplitude attenuation and phase shift of signals, which provides an estimation of a communications channel.

A term “inverse discrete Fourier transform (IDFT)” may refer to an algorithm which transforms a signal in frequency domain to a signal in time domain. In an example, the IDFT may be used to transform a channel state information into a TD-CRI. In an embodiment, an inverse fast Fourier transform (IFFT) may be used to implement the IDFT.

A term “full time-domain channel representation information (full TD-CRI)” may refer to a series of complex pairs of time domain pulses which are created by performing an IDFT or IFFT on channel state information values, for example channel state information calculated by a baseband receiver.

A term “channel representation information (CRI)” may refer to a collection of sensing measurements that together represent the state of the channel between two devices. Examples of CRI are channel state information and full TD-CRI.

A term “filtered time-domain channel representation information (filtered TD-CRI)” may refer to a reduced series of complex pairs of time domain pulses created by applying an algorithm to a full TD-CRI. The algorithm may select some time domain pulses and reject others. The filtered TD-CRI includes information that relates a selected time domain pulse to the corresponding time domain pulse in the full TD-CRI.

A term “Null Data PPDU (NDP)” may refer to a PPDU that does not include data fields. In an example, Null Data PPDU may be used for sensing transmissions where in examples it is the Medium Access Control (MAC) header that includes the information required.

A term “sensing transmission” may refer to any transmission made from a sensing transmitter to a sensing receiver that may be used to make a sensing measurement. In an example, sensing transmission may also be referred to as wireless sensing signal or wireless signal.

A term “sensing trigger message” may refer to a message sent from the sensing receiver to the sensing transmitter to trigger one or more sensing transmissions that may be used for performing sensing measurements. In an example, a sensing trigger message may be sent from a sensing transmitter to a sensing receiver to cause the sensing receiver to send a sensing measurement response message back to the sensing transmitter or to a sensing initiator.

A term “sensing response message” may refer to a message which is included within a sensing transmission from the sensing transmitter to the sensing receiver. In an example, the sensing transmission that includes the sensing response message may be used to perform a sensing measurement.

A term “sensing measurement” may refer to a measurement of a state of a channel i.e., channel state information measurement, between a sensing transmitter and a sensing receiver derived from a transmission, for example, a sensing transmission.

A term “transmission parameters” may refer to a set of IEEE 802.11 PHY transmitter configuration parameters which are defined as part of transmission vector (TXVECTOR) corresponding to a specific PHY and which are configurable for each PHY-layer Protocol Data Unit (PPDU) transmission.

A term “PHY-layer Protocol Data Unit (PPDU)” may refer to a data unit that includes preamble and data fields. The preamble field may include the transmission vector format information, and the data field may include payload and higher layer headers.

A term “channel response information (CRI) transmission message” may refer to a message sent by the sensing receiver that has performed a sensing measurement on a sensing transmission, in which the sensing receiver sends CRI to the sensing transmitter.

A term “time domain pulse” may refer to a complex number that represents amplitude and phase of discretized energy in the time domain. When channel state information values are obtained for each tone from the baseband receiver, time domain pulses are obtained by performing an inverse Fourier Transform (for example an IDFT or an IFFT) on the channel state information values.

A term “delivered transmission configuration” may refer to transmission parameters applied by the sensing transmitter to a sensing transmission.

A term “requested transmission configuration” may refer to requested transmission parameters of the sensing transmitter to be used when sending a sensing transmission.

A “transmission channel” may refer to a tunable channel on which the sensing receiver performs a sensing measurement and/or on which the sensing transmitter performs a sensing transmission.

A term “sensing transmission announcement message” may refer to a message which is sent from the sensing transmitter to the sensing receiver that announces that a sensing transmission NDP will follow within a short interframe space (SIFS). The sensing transmission NDP may be transmitted using transmission parameters defined with the sensing transmission announcement messages.

A term “sensing transmission NDP” may refer to an NDP transmission which is sent by the sensing transmitter and used for a sensing measurement at the sensing receiver. The transmission follows a sensing transmission announcement message and may be transmitted using transmission parameters that are defined in the sensing transmission announcement message.

A term “sensing measurement poll message” may refer to a message which is sent from the sensing transmitter to the sensing receiver to solicit the transmission of channel representation information that has been determined by the sensing receiver.

A term “sensing configuration message” may refer to a message which is sent from a device including a sensing algorithm (for example, a networked device) to the sensing receiver. The sensing configuration message may include a channel representation information configuration. The channel representation information configuration may interchangeably be referred to as Time Domain Channel Representation Information (TD-CRI) configuration.

A term “sensing configuration response message” may refer to a message sent from the sensing receiver to the device including the sensing algorithm (for example, the networked device) in response to a sensing configuration message. In an example, the sensing configuration response message may be an acknowledgement to the sensing configuration message.

A term “feature of interest” may refer to an item or state of an item which is positively detected and/or identified by a sensing algorithm.

A term “path of motion” may refer to a physical route that an object traveling through a sensing space takes. A path of motion may occur between transmitters and/or reflectors.

A term “sensing space” may refer to a physical space in which a Wi-Fi sensing system may operate.

A term “Wi-Fi sensing session” may refer to a period during which objects in a sensing space may be probed, detected and/or characterized. In an example, during a Wi-Fi sensing session, several devices participate in, and thereby contribute to the generation of sensing measurements. A Wi-Fi sensing session may also be referred to as a WLAN sensing session or simply a sensing session.

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes systems and methods that are useful for a Wi-Fi sensing system configured to send sensing transmissions and make sensing measurements.

Section C describes embodiments of systems and methods for identifying waveform frequency signature using time stamps.

### A. Wireless Communications System, Wireless Transmissions, and Sensing Measurements

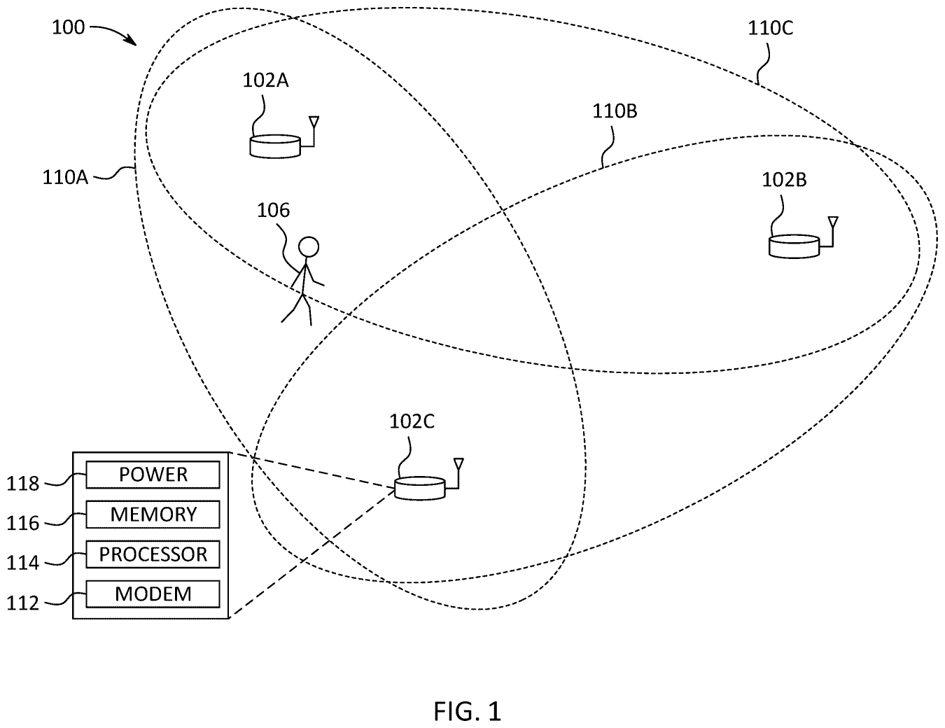

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a wireless local area network (WLAN), a personal area network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., Bluetooth®., Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as code division multiple access (CDMA), wideband code division multiple access (WCDMA), Universal Mobile Telecommunications System (UMTS), and time division synchronous code division multiple access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially-available Wi-Fi APs or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially-available mesh network system (e.g., Plume Wi-Fi, Google Wi-Fi, Qualcomm Wi-Fi SoN, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional, or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate RF signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and RF circuitry. The RF circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or may include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to RF signals, and wirelessly transmits the RF signals (e.g., through an antenna). In some instances, the radio subsystem in modem 112 wirelessly receives RF signals (e.g., through an antenna), down-converts the RF to baseband signals, and sends the baseband signals to the baseband subsystem. The signals exchanged between the radio subsystem and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes received motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

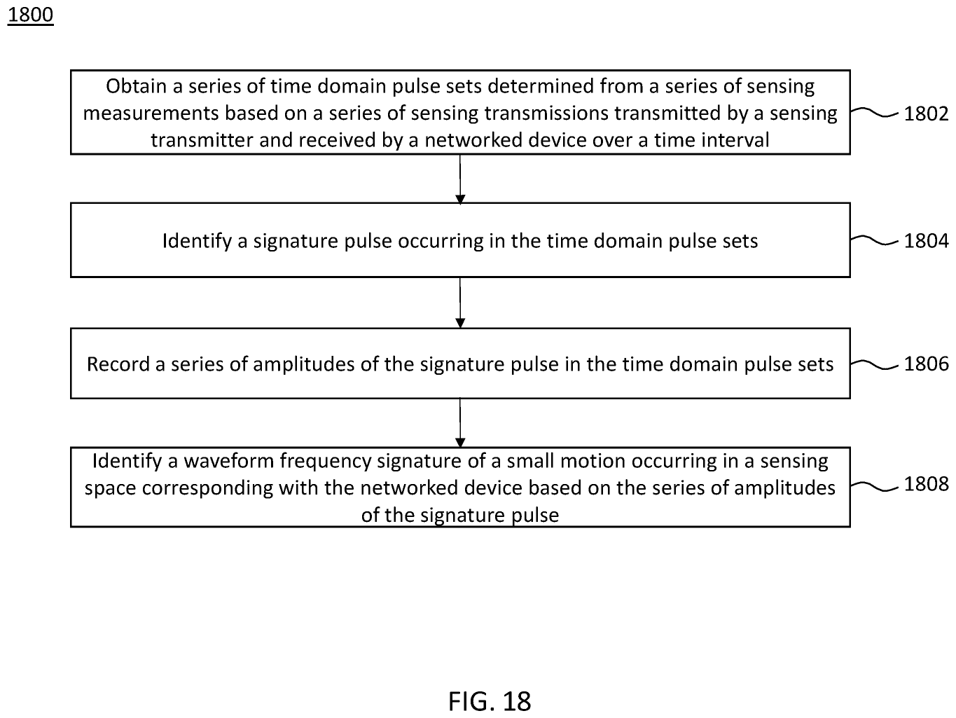

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for time-aligning signals using an interference buffer and a motion detection buffer, such as through one or more of the operations of the example process of FIG. 18. Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an alternating current (AC) adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example process described below with respect to FIG. 18, or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 110B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 110A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly, an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

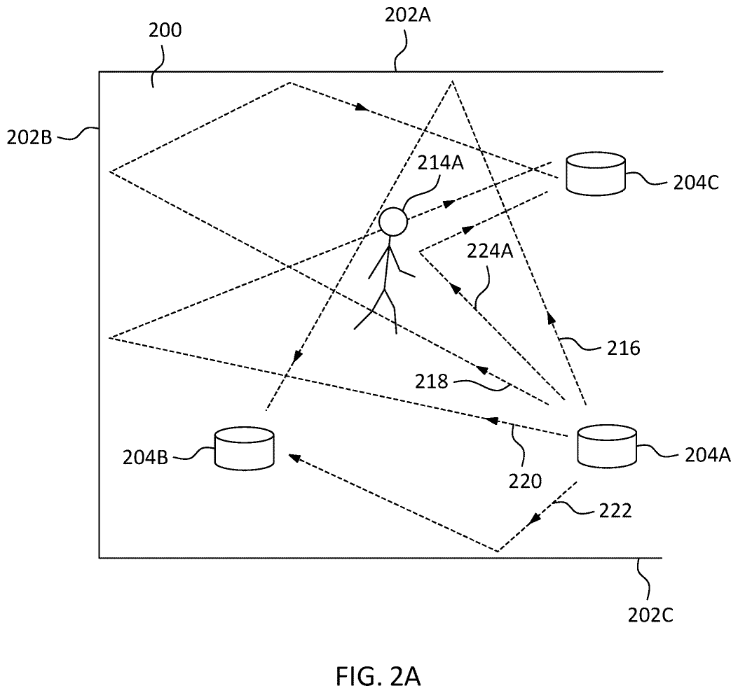

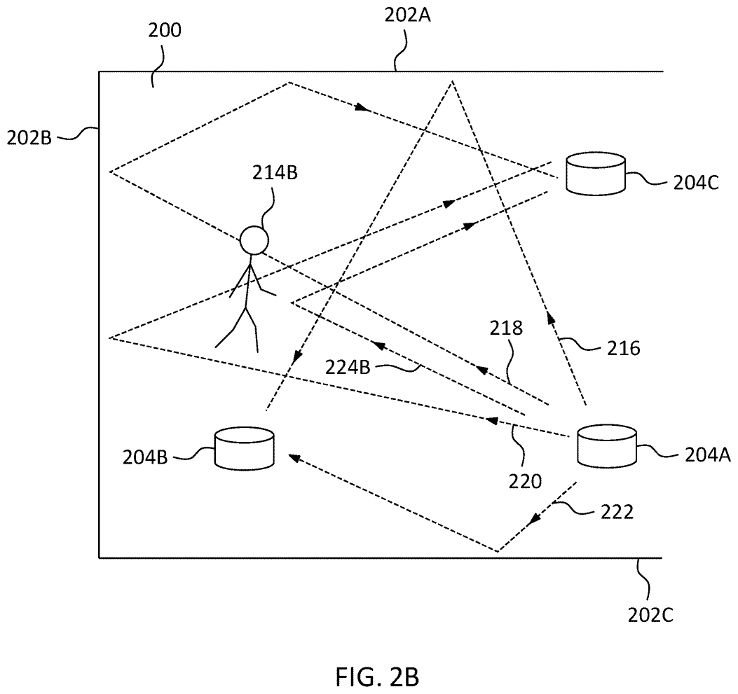

FIG. 2A and FIG. 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. In an example, space 200 may be a sensing space. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIG. 2A and FIG. 2B, wireless communication device 204A is operable to transmit wireless signals repeatedly (e.g., periodically, intermittently, at scheduled, unscheduled or random intervals, etc.). Wireless communication devices 204B, 204C are operable to receive signals based on those transmitted by wireless communication device 204A. Wireless communication devices 204B, 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIG. 2A and FIG. 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIG. 2A and FIG. 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIG. 2A and FIG. 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIG. 2A and FIG. 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIG. 2A and FIG. 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIG. 2A and FIG. 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal—will also change. A change in the received signal can be used to detect movement of an object.

Mathematically, a transmitted signal f(t) transmitted from the first wireless communication device 204A may be described according to Equation (1):

$$f ( t ) = {\sum }_{n = - ∞}^{∞} {c}_{n} {e}^{j {ω}_{n} t} \qquad ( 1 )$$

Where ωₙ represents the frequency of nth frequency component of the transmitted signal, cₙ represents the complex coefficient of the nth frequency component, and t represents time. With the f(t) being transmitted from the first wireless communication device 204A, an output signal rₖ(t) from a path, k, may be described according to Equation (2):

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

Where α_{n,k} represents an attenuation factor (or channel response; e.g., due to scattering, reflection, and path losses) for the nth frequency component along k, and φ_{n,k} represents the phase of the signal for nth frequency component along k. Then, the received signal, R, at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

R at a wireless communication device can then be analyzed. R at a wireless communication device can be transformed to the frequency domain, for example, using a fast Fourier transform (FFT) or another type of algorithm. The transformed signal can represent R as a series of n complex values, one for each of the respective frequency components (at the n frequencies ωₙ). For a frequency component at frequency ωₙ, a complex value, Hₙ, may be represented as follows in Equation (5):

$${H}_{n} = {\sum }_{k} {c}_{n} {α}_{n , k} {e}^{j {ϕ}_{n , k}} \qquad ( 5 )$$

Hₙ for a given ωₙ indicates a relative magnitude and phase offset of the received signal at ωₙ. When an object moves in the space, Hₙ changes due to α_{n,k} of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

$${h}_{ch} = {\sum }_{k} {\sum }_{n = - ∞}^{∞} {α}_{n , k} \qquad ( 6 )$$

In some instances, the channel response, h_{ch}, for a space can be determined, for example, based on the mathematical theory of estimation. For instance, a reference signal, R_{ef}, can be modified with candidate h_{ch}, and then a maximum likelihood approach can be used to select the candidate channel which gives best match to the received signal (R_{cvd}). In some cases, an estimated received signal (\hat{R}_{cvd}) is obtained from the convolution of R_{ef} with the candidate h_{ch}, and then the channel coefficients of h_{ch} are varied to minimize the squared error of \hat{R}_{cvd}. This can be mathematically illustrated as follows in Equation (7):

$${R}_{cvd} = {R}_{ef} ⊗ {h}_{ch} = {\sum }_{k = - m}^{m} {R}_{ef} ( n - k ) {h}_{ch} ( k ) \qquad ( 7 )$$

with the optimization criterion

$${min}_{{h}_{c h}} \{ \sum {( {\hat{R}}_{cvd} - {R}_{cvd} )}^{2} \}$$

The minimizing, or optimizing, process can utilize an adaptive filtering technique, such as least mean squares (LMS), recursive least squares (RLS), batch least squares (BLS), etc. The channel response can be a finite impulse response (FIR) filter, infinite impulse response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

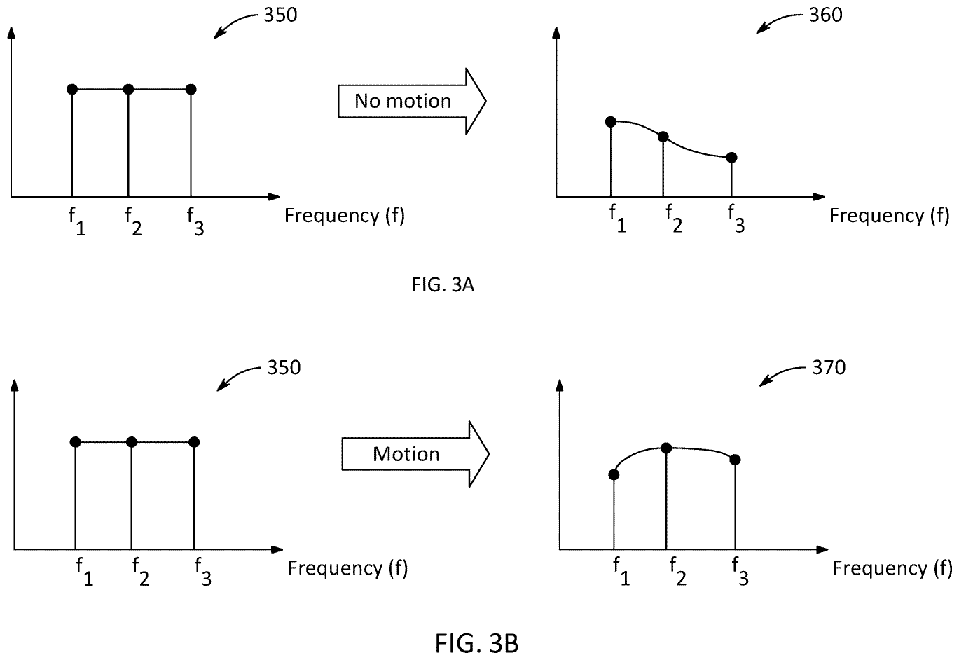

FIG. 3A and FIG. 3B are plots showing examples of channel responses 360, 370 computed from the wireless signals communicated between wireless communication devices 204A, 204B, 204C in FIG. 2A and FIG. 2B. FIG. 3A and FIG. 3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIG. 3A and FIG. 3B, for illustration purposes, wireless communication device 204A transmits a signal that has a flat frequency profile (the magnitude of each frequency component, f₁, f₂ and f₃ is the same), as shown in frequency domain representation 350. Because of the interaction of the signal with space 200 (and the objects therein), the signals received at wireless communication device 204B that are based on the signal sent from wireless communication device 204A are different from the transmitted signal. In this example, where the transmitted signal has a flat frequency profile, the received signal represents the channel response of space 200. As shown in FIG. 3A and FIG. 3B, channel responses 360, 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space 200.

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

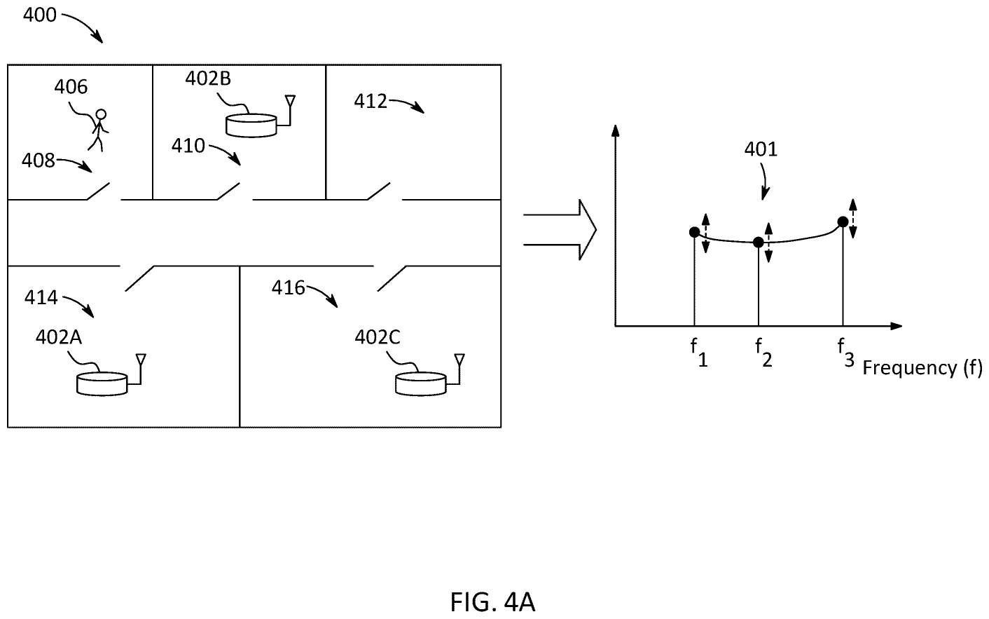

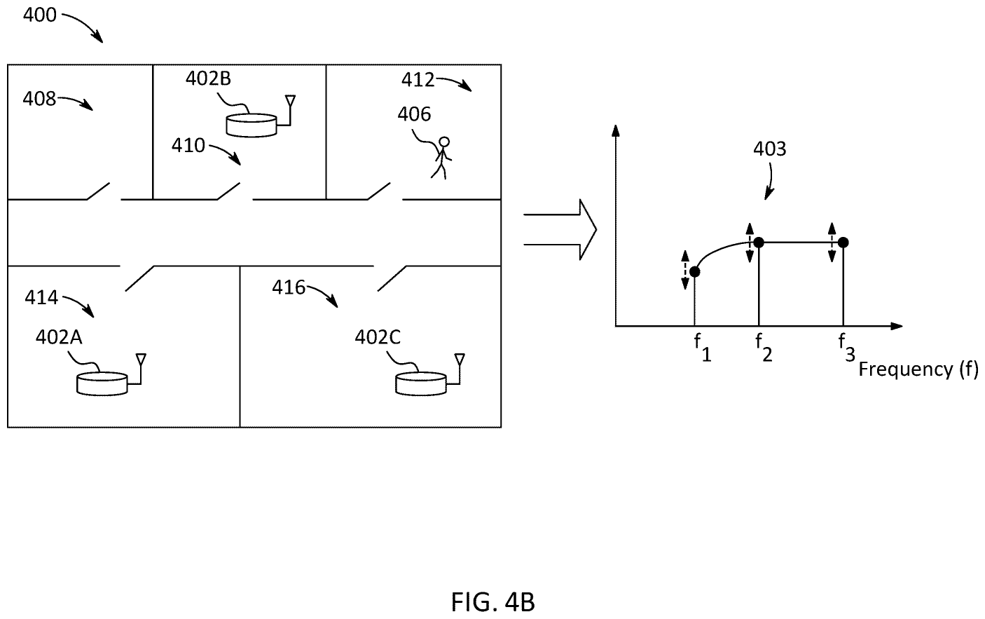

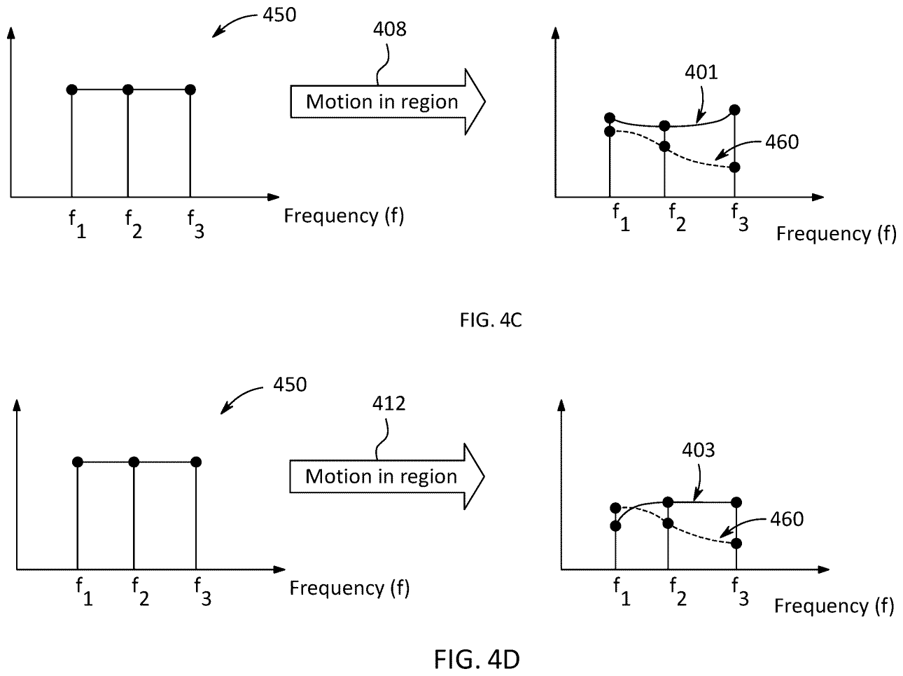

FIG. 4A and FIG. 4B are diagrams showing example channel responses 401, 403 associated with motion of object 406 in distinct regions 408, 412 of space 400. In the examples shown, space 400 is a building, and space 400 is divided into a plurality of distinct regions—first region 408, second region 410, third region 412, fourth region 414, and fifth region 416. Space 400 may include additional or fewer regions, in some instances. As shown in FIG. 4A and FIG. 4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 406, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of f₁, f₂ and f₃ is the same or nearly the same. For example, the motion probe signals may have a frequency response similar to frequency domain representation 350 shown in FIG. 3A and FIG. 3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel responses 401, 403 are associated with signals received by the same wireless communication device 402 in space 400.

FIG. 4C and FIG. 4D are plots showing channel responses 401, 403 of FIG. 4A and FIG. 4B overlaid on channel response 460 associated with no motion occurring in space 400. In the example shown, wireless communication device 402 transmits a motion probe signal that has a flat frequency profile as shown in frequency domain representation 450. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained artificial intelligence (AI) model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each of f₁, f₂, and f₃ is less than the previous). The profile of channel response 460 may differ in some instances (e.g., based on different room layouts or placement of wireless communication devices 402).

When motion occurs in space 400, a variation in the channel response will occur. For instance, in the examples shown in FIG. 4C and FIG. 4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component, f₂, is less than the outer frequency components f₁ and f₃), while channel response 403 has a convex-asymptotic frequency profile (the magnitude of the middle frequency component f₂ is greater than the outer frequency components, f₁ and f₃). The profiles of channel responses 401, 403 may differ in some instances (e.g., based on different room layouts or placement of the wireless communication devices 402).

Analyzing channel responses may be considered similar to analyzing a digital filter. A channel response may be formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points, or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). By looking this range of values, unique profiles (in examples profiles may also be referred to as signatures) may be identified for distinct regions within a space.

In some implementations, an AI model may be used to process data. AI models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all AI models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIG. 4A and FIG. 4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an AI model may be trained using the tagged channel responses, and once trained, newly computed channel responses can be input to the AI model, and the AI model can output a location of the detected motion. For example, in some cases, mean, range, and absolute values are input to an AI model. In some instances, magnitude and phase of the complex channel response itself may be input as well. These values allow the AI model to design arbitrary front-end filters to pick up the features that are most relevant to making accurate predictions with respect to motion in distinct regions of a space. In some implementations, the AI model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier based decision surfaces. The decision surfaces divide different clusters and subsequent layers can form categories based on a single cluster or a combination of clusters.

In some implementations, an AI model includes two or more layers of inference. The first layer acts as a logistic classifier which can divide different concentration of values into separate clusters, while the second layer combines some of these clusters together to create a category for a distinct region. Additional, subsequent layers can help in extending the distinct regions over more than two categories of clusters. For example, a fully-connected AI model may include an input layer corresponding to the number of features tracked, a middle layer corresponding to the number of effective clusters (through iterating between choices), and a final layer corresponding to different regions. Where complete channel response information is input to the AI model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Wi-Fi Sensing System Example Methods and Apparatus

Section B describes systems and methods that are useful for a wireless sensing system configured to send sensing transmissions and make sensing measurements.

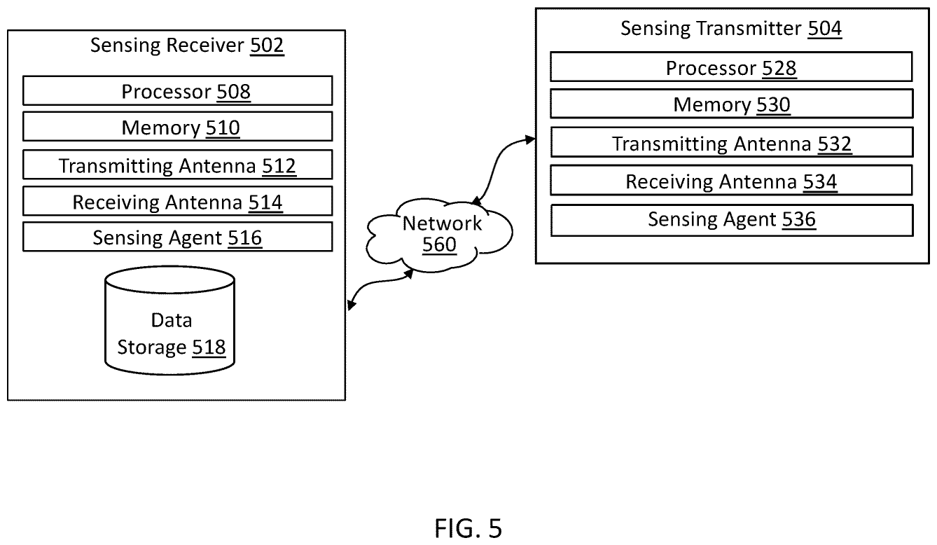

FIG. 5 depicts some of an architecture of an implementation of system 500 for Wi-Fi sensing, according to some embodiments.

System 500 may include sensing receiver 502, sensing transmitter 504, and network 560 enabling communication between the system components for information exchange. System 500 may be an example or instance of wireless communication system 100, and network 560 may be an example or instance of wireless network or cellular network, details of which are provided with reference to FIG. 1 and its accompanying description.

According to an embodiment, sensing receiver 502 may be configured to receive a sensing transmission (for example, from sensing transmitter 504) and perform one or more measurements (for example, channel state information) useful for Wi-Fi sensing. These measurements may be known as sensing measurements. The sensing measurements may be processed to achieve a sensing result of system 500, such as detecting motions or gestures. In an embodiment, sensing receiver 502 may be an AP. In some embodiments, sensing receiver 502 may take a role of sensing initiator.

According to an implementation, sensing receiver 502 may be implemented by a device, such as wireless communication device 102 shown in FIG. 1. In some implementations, sensing receiver 502 may be implemented by a device, such as wireless communication device 204 shown in FIG. 2A and FIG. 2B. Further, sensing receiver 502 may be implemented by a device, such as wireless communication device 402 shown in FIG. 4A and FIG. 4B. In some embodiments, sensing receiver 502 may be any computing device, such as a desktop computer, a laptop, a tablet computer, a mobile device, a personal digital assistant (PDA), or any other computing device. According to an implementation, sensing receiver 502 may be enabled to control a measurement campaign to ensure that required sensing transmissions are made at a required time and to ensure an accurate determination of sensing measurements. In some embodiments, sensing receiver 502 may process sensing measurements to achieve the sensing result of system 500. In some embodiments, sensing receiver 502 may be configured to transmit sensing measurements to sensing transmitter 504, and sensing transmitter 504 may be configured to process the sensing measurements to achieve the sensing result of system 500.

Referring again to FIG. 5, in some embodiments, sensing transmitter 504 may form a part of a basic service set (BSS) and may be configured to send a sensing transmission to sensing receiver 502 based on which one or more sensing measurements (for example, channel state information) may be performed for Wi-Fi sensing. In an embodiment, sensing transmitter 504 may be a station (STA). In an embodiment, sensing transmitter 504 may be an access point (AP). According to an implementation, sensing transmitter 504 may be implemented by a device, such as wireless communication device 102 shown in FIG. 1. In some implementations, sensing transmitter 504 may be implemented by a device, such as wireless communication device 204 shown in FIG. 2A and FIG. 2B. Further, sensing transmitter 504 may be implemented by a device, such as wireless communication device 402 shown in FIG. 4A and FIG. 4B. In some embodiments, sensing transmitter 504 may be any computing device, such as a desktop computer, a laptop, a tablet computer, a mobile device, a personal digital assistant (PDA), or any other computing device. In some implementations, communication between sensing receiver 502 and sensing transmitter 504 may happen via station management entity (SME) and MAC layer management entity (MLME) protocols.

Referring to FIG. 5, in more detail, sensing receiver 502 may include processor 508 and memory 510. For example, processor 508 and memory 510 of sensing receiver 502 may be processor 114 and memory 116, respectively, as shown in FIG. 1. In an embodiment, sensing receiver 502 may further include transmitting antenna(s) 512, receiving antenna(s) 514, and sensing agent 516.

In an implementation, sensing agent 516 may be responsible for receiving sensing transmissions and associated transmission parameters, calculating sensing measurements, and processing sensing measurements to fulfill a sensing result. In some implementations, receiving sensing transmissions and associated transmission parameters, and calculating sensing measurements may be carried out by an algorithm running in the MAC layer of sensing receiver 502 and processing sensing measurements to fulfill a sensing result may be carried out by an algorithm running in the application layer of sensing receiver 502. In some examples, the algorithm running in the application layer of sensing receiver 502 is known as a sensing application or sensing algorithm. In some implementations, the algorithm running in the MAC layer of sensing receiver 502 and the algorithm running in the application layer of sensing receiver 502 may run separately on processor 508. In an implementation, sensing agent 516 may pass physical layer parameters (e.g., such as channel state information) from the MAC layer of sensing receiver 502 to the application layer of sensing receiver 502 and may use the physical layer parameters to detect one or more features of interest. In an example, the application layer may operate on the physical layer parameters and form services or features, which may be presented to an end-user. According to an implementation, communication between the MAC layer of sensing receiver 502 and other layers or components may take place based on communication interfaces, such as MLME interface and a data interface. According to some implementations, sensing agent 516 may include/execute a sensing algorithm. In an implementation, sensing agent 516 may process and analyze sensing measurements using the sensing algorithm and identify one or more features of interest. Further, sensing agent 516 may be configured to determine a number and timing of sensing transmissions and sensing measurements for the purpose of Wi-Fi sensing. In some implementations, sensing agent 516 may be configured to transmit sensing measurements to sensing transmitter 504 for further processing.

In an implementation, sensing agent 516 may be configured to cause at least one transmitting antenna of transmitting antenna(s) 512 to transmit messages to sensing transmitter 504. Further, sensing agent 516 may be configured to receive, via at least one receiving antenna of receiving antennas(s) 514, messages from sensing transmitter 504. In an example, sensing agent 516 may be configured to make sensing measurements based on one or more sensing transmissions received from sensing transmitter 504.

Referring again to FIG. 5, sensing receiver 502 may include data storage 518. In an implementation, data storage 518 may store a series of amplitudes of a signature pulse in time domain pulse sets. In examples, data storage 518 may store a base amplitude, an amplitude, and a waveform amplitude variation of a signature pulse at different sensing measurement times such as t₁, t₂, . . . , t₁, . . . , t_{N} (also referred to as timestamps). Information stored in data storage 518 may be periodically or dynamically updated as required. In an implementation, data storage 518 may include any type or form of storage, such as a database or a file system coupled to memory 510.

Referring again to FIG. 5, sensing transmitter 504 may include processor 528 and memory 530. For example, processor 528 and memory 530 of sensing transmitter 504 may be processor 114 and memory 116, respectively, as shown in FIG. 1. In an embodiment, sensing transmitter 504 may further include transmitting antenna(s) 532, receiving antenna(s) 534, and sensing agent 536. In an implementation, sensing agent 536 may be a block that passes physical layer parameters from the MAC of sensing transmitter 504 to application layer programs. Sensing agent 536 may be configured to cause at least one transmitting antenna of transmitting antenna(s) 532 and at least one receiving antenna of receiving antennas(s) 534 to exchange messages with sensing receiver 502.

In an implementation, sensing agent 536 may be responsible for receiving sensing measurements and associated transmission parameters, calculating sensing measurements, and/or processing sensing measurements to fulfill a sensing result. In some implementations, receiving sensing measurements and associated transmission parameters, and calculating sensing measurements and/or processing sensing measurements may be carried out by an algorithm running in the MAC layer of sensing transmitter 504, and processing sensing measurements to fulfill a sensing result may be carried out by an algorithm running in the application layer of sensing transmitter 504. In some examples, the algorithm running in the application layer of sensing transmitter 504 is known as a sensing application or sensing algorithm. In some implementations, the algorithm running in the MAC layer of sensing transmitter 504 and the algorithm running in the application layer of sensing transmitter 504 may run separately on processor 528. In an implementation, sensing agent 536 may pass physical layer parameters (e.g., such as channel state information) from the MAC layer of sensing transmitter 504 to the application layer of sensing transmitter 504 and may use the physical layer parameters to detect one or more features of interest. In an example, the application layer may operate on the physical layer parameters and form services or features, which may be presented to an end-user. According to an implementation, communication between the MAC layer of sensing transmitter 504 and other layers or components may take place based on communication interfaces, such as MLME interface and a data interface. According to some implementations, sensing agent 536 may include/execute a sensing algorithm. In an implementation, sensing agent 536 may process and analyze sensing measurements using the sensing algorithm and identify one or more features of interest. Further, sensing agent 536 may be configured to determine a number and timing of sensing transmissions and sensing measurements for the purpose of Wi-Fi sensing.

In some embodiments, an antenna may be used to both transmit and receive in a half-duplex format. When the antenna is transmitting, it may be referred to as transmitting antenna 512/532, and when the antenna is receiving, it may be referred to as receiving antenna 514/534. It is understood by a person of normal skill in the art that the same antenna may be transmitting antenna 512/532 in some instances and receiving antenna 514/534 in other instances. In the case of an antenna array, one or more antenna elements may be used to transmit or receive a signal, for example, in a beamforming environment. In some examples, a group of antenna elements used to transmit a composite signal may be referred to as transmitting antenna 512/532, and a group of antenna elements used to receive a composite signal may be referred to as receiving antenna 514/534. In some examples, each antenna is equipped with its own transmission and receive paths, which may be alternately switched to connect to the antenna depending on whether the antenna is operating as transmitting antenna 512/532 or receiving antenna 514/534.

According to one or more implementations, communications in network 560 may be governed by one or more of the 802.11 family of standards developed by IEEE. Some example IEEE standards may include IEEE 802.11-2020, IEEE 802.11ax-2021, IEEE 802.11me, IEEE 802.11az, and IEEE 802.11be. IEEE 802.11-2020 and IEEE 802.11ax-2021 are fully-ratified standards whilst IEEE 802.11me reflects an ongoing maintenance update to the IEEE 802.11-2020 standard and IEEE 802.11be defines the next generation of standard. IEEE 802.11az is an extension of the IEEE 802.11-2020 and IEEE 802.11 ax-2021 standards, adding new functionality. In some implementations, communications may be governed by other standards (other or additional IEEE standards or other types of standards). In some embodiments, parts of network 560 which are not required by system 500 to be governed by one or more of the 802.11 family of standards may be implemented by an instance of any type of network, including wireless network or cellular network.

Referring to FIG. 5, according to one or more implementations, for the purpose of Wi-Fi sensing, the role of sensing initiator may be taken on by sensing receiver 502. In an implementation, a networked device may send a sensing configuration message to sensing receiver 502. In an example, the sensing configuration message may include a channel representation information configuration. In response to the sensing configuration message, sensing receiver 502 may send an acknowledgment using a sensing configuration response message and configure itself with the channel representation information configuration for use in time-domain channel representation information (TD-CRI) or filtered TD-CRI. Thereafter, in an example, sensing receiver 502 may initiate a sensing session and send a sensing trigger message to sensing transmitter 504 requesting a sensing transmission. Sensing transmitter 504 may then send a sensing transmission to sensing receiver 502 in response to the sensing trigger message. Upon receiving the sensing transmission, sensing receiver 502 may perform a channel state measurement on the received sensing transmission and generate channel representation information using the channel representation information configuration. In an example, sensing receiver 502 may generate TD-CRI or filtered TD-CRI. Further, sensing receiver 502 may send a CRI transmission message including the channel state measurement (i.e., TD-CRI or filtered TD-CRI) to the networked device for further processing.

According to some embodiments, the role of sensing initiator may be taken on by sensing transmitter 504. In an implementation, a networked device may send a sensing configuration message to sensing transmitter 504. In an example, the sensing configuration message may include a channel representation information configuration. In response to the sensing configuration message, sensing transmitter 504 may send an acknowledgment using a sensing configuration response message. Thereafter, in an example, sensing transmitter 504 may initiate a sensing session and send a sensing transmission announcement message followed by a sensing transmission NDP to sensing receiver 502. In an example, the sensing transmission announcement message may include a channel representation information configuration, and in examples the sensing receiver may configure itself with the channel representation information configuration for use in generating TD-CRI or filtered TD-CRI. In an example, the sensing transmission NDP follows the sensing transmission announcement message after one SIFS. In an example, the duration of SIFS is 10 μs. Sensing receiver 502 may perform a channel state measurement on the sensing transmission NDP and generate channel representation information based on the channel representation information configuration. In an example, the sensing receiver 502 may generate TD-CRI or filtered TD-CRI. Sensing receiver 502 may send a CRI transmission message including the channel state measurement (i.e., TD-CRI or filtered TD-CRI) to the networked device for further processing.

In an example, sensing receiver 502 may hold the channel state measurement until it receives a sensing measurement poll message. Sensing transmitter 504 may send a sensing measurement poll message to sensing receiver 502, which may trigger sensing receiver 502 to send an already formatted channel state measurement (i.e., channel state information, TD-CRI, or filtered TD-CRI) to sensing transmitter 504. In another example, sensing transmitter 504 may send a sensing measurement poll message to sensing receiver 502, which includes a channel representation information configuration. The sensing measurement poll message may trigger sensing receiver 502 to generate TD-CRI or filtered TD-CRI according to the channel representation information configuration, and to transfer TD-CRI or filtered TD-CRI to sensing transmitter 504. In examples, sensing receiver 502 may send a CRI transmission message including the channel state measurement (i.e., TD-CRI or filtered TD-CRI) to the networked device.

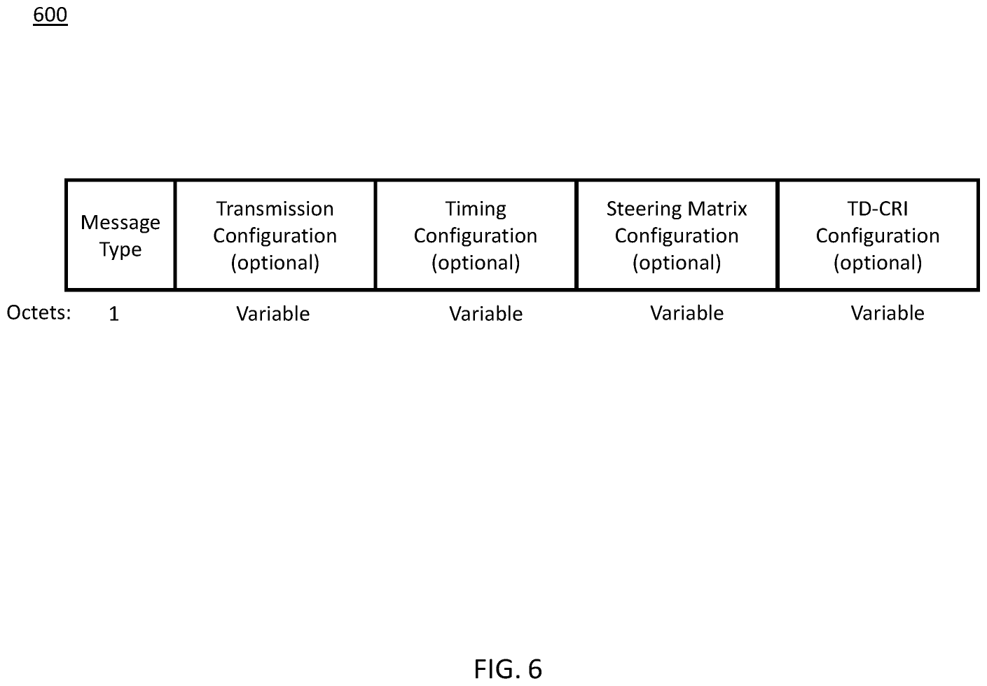

Some embodiments of the present disclosure as described above define sensing message types for Wi-Fi sensing, for example, sensing configuration message and sensing configuration response message. In an example, the sensing configuration message and the sensing configuration response message are carried in a new extension to a management frame of a type described in IEEE 802.11. FIG. 6 illustrates an example of a component of a management frame 600 carrying a sensing transmission. In an example, system 500 may require acknowledgement frames, and the management frame carrying sensing messages may be implemented as an Action frame and in another example, system 500 may not require acknowledgement frames, and the management frame carrying sensing messages may be implemented as an Action No Ack frame.

In an implementation, the information content of all sensing message types may be carried in a format as shown in FIG. 6. In some examples, Transmission Configuration, Timing Configuration, Steering Matrix Configuration, and TD-CRI configuration as described in FIG. 6 are implemented as IEEE 802.11 elements. In some examples, the TD-CRI Configuration element is a part of the Transmission Configuration element.

In one or more embodiments, the sensing message types may be identified by the message type field, and each sensing message type may carry other identified elements, according to some embodiments. In an example, data may be encoded into an element for inclusion in sensing messages between sensing receiver 502, sensing transmitter 504, and the networked device. In a measurement campaign involving multiple sensing receivers and multiple sensing transmitters, these parameters may be defined for all sensing receivers-sensing transmitters pairs. In an example, when these parameters are transmitted from the networked device to sensing receiver 502, then these parameters configure sensing receiver 502 to process a sensing transmission and calculate sensing measurements. In some examples, when these parameters are transmitted from sensing receiver 502 to the networked device, then these parameters report the configuration used by sensing receiver 502.

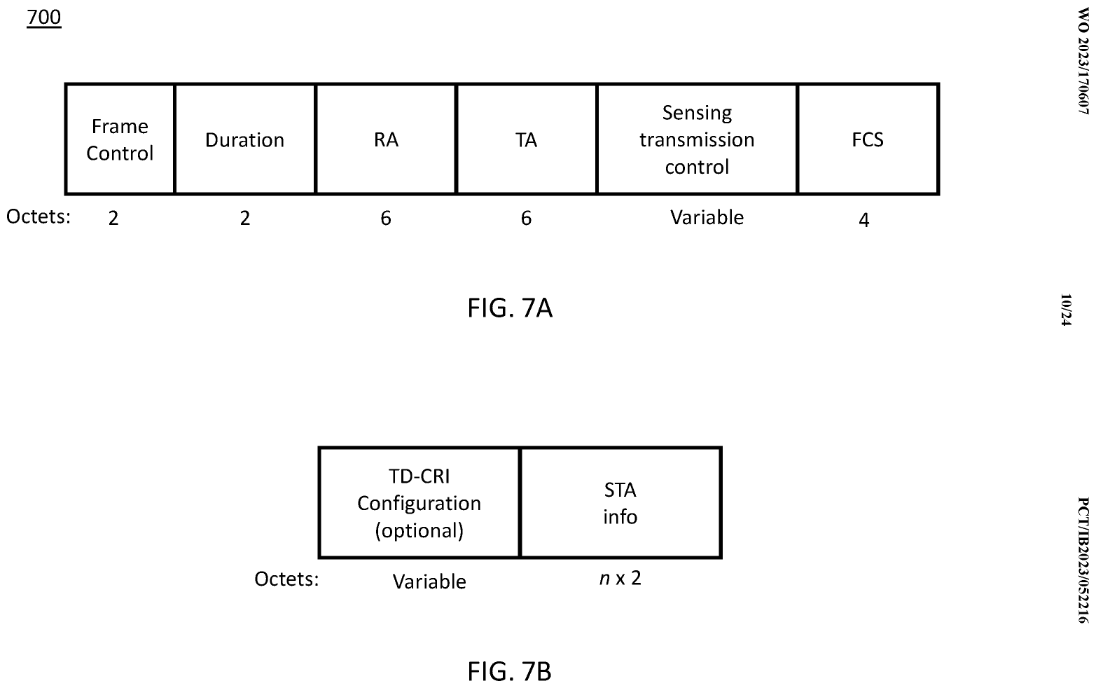

According to some implementations, a sensing transmission announcement may be carried in a new extension to a control frame of a type described in IEEE 802.11. In some implementations, the sensing transmission announcement may be carried in a new extension to a control frame extension described in IEEE 802.11. FIG. 7A illustrates an example of a format of control frame 700 and FIG. 7B illustrates a format of a sensing transmission control field of control frame 700. In an example, the STA info field of the sensing transmission control field may address up to n sensing receivers via their association ID (AID). In an example implementation, the sensing transmission announcement may address n sensing receivers that are required to make a sensing measurement and to relay channel representation information back to the sensing initiator.

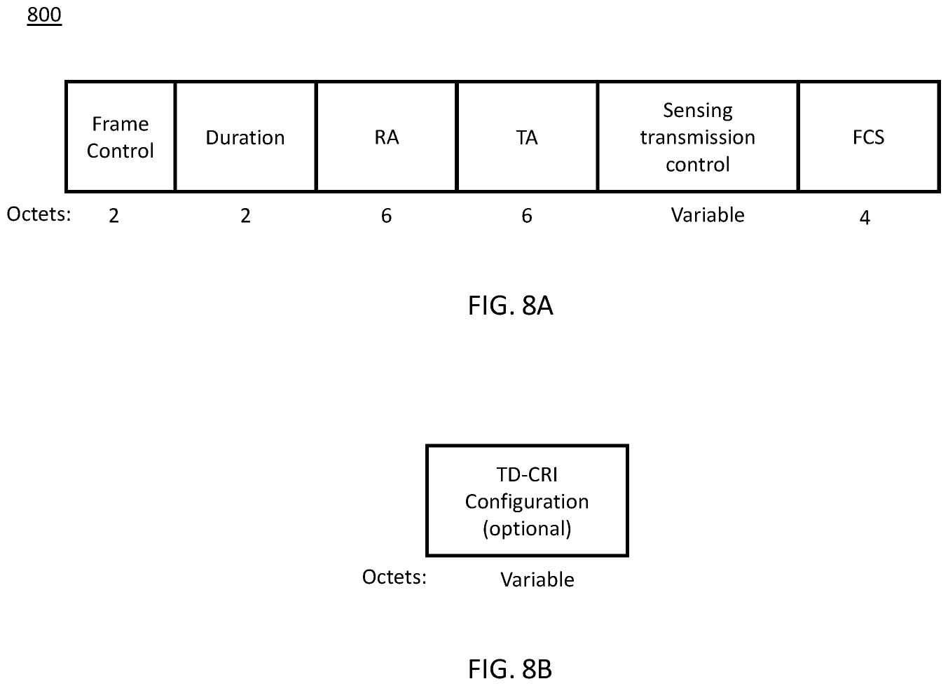

According to some implementations, a sensing measurement poll may be carried in a new extension to a control frame of a type described in IEEE 802.11. In some implementations, the sensing measurement poll may be carried in a new extension to a control frame extension described in IEEE 802.11. FIG. 8A illustrates an example of a format of control frame 800 and FIG. 8B illustrates a format of a sensing measurement control field of control frame 800.

According to some implementations, when sensing receiver 502 has calculated sensing measurements and created channel representation information (for example, in a form of TD-CRI), the sensing receiver 502 may be required to communicate the channel representation information to sensing transmitter 504 or the networked device. In an example, the TD-CRI may be transferred by a management frame. In an example, a message type may be defined, which represents a CRI transmission message.

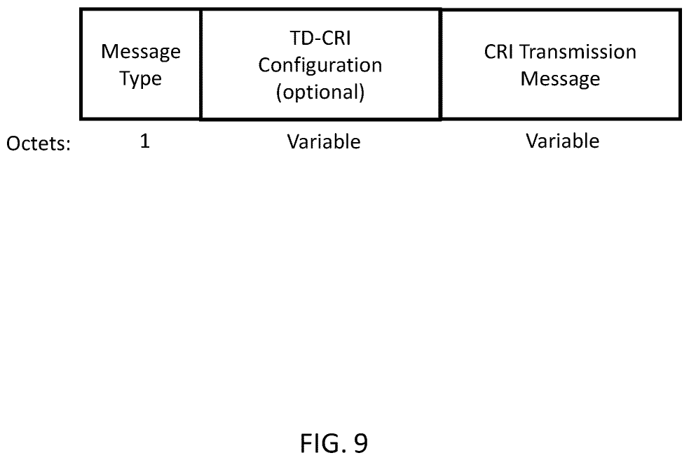

FIG. 9 illustrates an example of a component of a management frame 900 carrying a CRI transmission message, according to some embodiments. In an example, system 500 may require acknowledgement frames, and the management frame carrying the CRI transmission message may be implemented as an Action frame, and in another example, system 500 may not require acknowledgement frames, and the management frame carrying the CRI transmission message may be implemented as an Action No Ack frame.

In an implementation, when the networked device is implemented on a separate device (i.e., is not implemented within sensing receiver 502 or sensing transmitter 504), a management frame may not be necessary, and the TD-CRI may be encapsulated in a standard IEEE 802.11 data frame and transferred to the networked device. In an example, a proprietary header or descriptor may be added to the data structure to allow the networked device to detect that the data structure is of the form of a CRI transmission message Element. In an example, data may be transferred in the format shown in FIG. 9 and the networked device may be configured to interpret the Message Type value that represents a CRI transmission message Element.

### C. Systems and Methods for Identifying Waveform Frequency Signature Using Timestamps

The present disclosure generally relates to systems and methods for Wi-Fi sensing. In particular, the present disclosure relates to systems and methods for identifying waveform frequency signature using timestamps.

Currently, a Wi-Fi sensing system can detect a small motion of an object existing between a sensing transmitter and a sensing receiver. Further, if the small motion has a waveform frequency signature (i.e., periodic similar motions along a timeline such as a movement of human breathing or a movement of a small pump machine), there may be a further demand of a more accurate Wi-Fi sensing system to identify the waveform frequency signature of the small motion. In examples, a waveform frequency signature of a small motion of an object in a sensing space may be beneficial in certain applications, such as home monitoring, assisted living, security monitoring, etc. In an example, a waveform frequency signature of a small motion (for example, breathing) of a human in sleep may be helpful to identify if the breathing of the human is normal or not.

In examples, reflections of time domain pulses between the sensing transmitter and the sensing receiver may result in multipath signals at the sensing receiver. The multipath signals at the sensing receiver may have different amplitudes and time delays. The small, repetitive (for example, periodic) motion of an object in the path of the reflected time domain pulses may cause amplitude modulations of the received time domain pulses when the movement of the object reflects the time domain pulses in its path. In wireless telecommunications, multipath is a propagation phenomenon that results in radio signals reaching receiving antennas by two or more paths.

The present disclosure describes a solution to identify a waveform frequency signature (or frequency) of a small motion of an object in a path of multipath signals between a sensing transmitter and a sensing receiver. According to an implementation, a waveform frequency signature of the small motion of the object may be identified by detecting waveform amplitude variations (or modulations) on top of base amplitudes of received time domain pulses from the series of multipath signals at different timestamps and finding a maximum correlation between a set of reasonable frequencies and the detected waveform amplitude variations across the time series of multipath signals.

Referring to FIG. 5, according to one or more implementations, for the purpose of Wi-Fi sensing, sensing receiver 502 or sensing transmitter 504 may initiate a measurement campaign (or a Wi-Fi sensing session). In the measurement campaign, exchange of transmissions between sensing receiver 502 and sensing transmitter 504 may occur. In an example, control of these transmissions may be by the MAC layer of the IEEE 802.11 stack.

According to an example implementation, sensing receiver 502 may initiate the measurement campaign via one or more sensing trigger messages. In an implementation, sensing agent 516 may be configured to generate a sensing trigger message configured to trigger a series of sensing transmissions from sensing transmitter 504. In an example, the sensing trigger message may include a requested transmission configuration field. Other examples of information/data included in the sensing trigger message that are not discussed here are contemplated herein. According to an implementation, sensing agent 516 may transmit the sensing trigger message to sensing transmitter 504. In an implementation, sensing agent 516 may transmit the sensing trigger message to sensing transmitter 504 via transmitting antenna 512 to trigger a series of sensing transmissions from sensing transmitter 504.

Sensing transmitter 504 may be configured to receive the sensing trigger message from sensing receiver 502 via receiving antenna 534. In response to receiving the sensing trigger message, sensing transmitter 504 may generate a series of sensing transmissions. In an example, one or more transmissions of the series of sensing transmissions that the sensing trigger message triggers from sensing transmitter 504 may comprise a sensing response message. In an implementation, sensing transmitter 504 may generate one or more transmissions of the series of sensing transmissions using the requested transmission configuration. In an implementation, sensing transmitter 504 may transmit one or more sensing transmissions of the series of sensing transmissions to sensing receiver 502 in response to the sensing trigger message and in accordance with the requested transmission configuration. In an implementation, sensing transmitter 504 may transmit the series of sensing transmissions to sensing receiver 502 via transmitting antenna 532.

In an implementation, sensing receiver 502 may receive the series of sensing transmissions from sensing transmitter 504 transmitted in response to the sensing trigger message. Sensing receiver 502 may be configured to receive the series of sensing transmissions from sensing transmitter 504 via receiving antenna 514. According to an implementation, sensing agent 516 may be configured to generate a series of sensing measurements based on the series of sensing transmissions received from sensing transmitter 504. Further, sensing agent 516 may be configured to determine a plurality of channel representation information based on the series of sensing measurements. In an implementation, the plurality of channel representation information may include a full time-domain channel representation information (TD-CRI) or a filtered TD-CRI. According to an example, the plurality of channel representation information may include a series of time domain pulse sets. In an example, the plurality of channel representation information may be calculated by a baseband processor in sensing receiver 502 as a part of the normal signal processing that takes place when the series of sensing transmissions is received. In an example implementation, sensing agent 516 may calculate the TD-CRI using an inverse Fourier transform, such as an inverse discrete Fourier transform (IDFT) or an inverse fast Fourier transform (IFFT).

According to some implementations, sensing agent 516 may transmit the plurality of channel representation information to sensing transmitter 504 for further processing. In an implementation, sensing agent 516 may communicate the plurality of channel representation information to sensing transmitter 504 via a channel representation information (CRI) transmission message. According to an implementation, sensing agent 516 may transmit the CRI transmission message to sensing transmitter 504 via transmitting antenna 512.

In the time domain, a transmission channel may be referred to as h(t). The transmission channel may also be described as an impulse response of the transmission channel. The impulse response of the transmission channel may include a plurality of time domain pulses. The plurality of time domain pulses may represent reflections that transmitted signals (for example, those transmitted by a transmitter) underwent before reaching a receiver. A reflected time domain pulse may be represented as:

$$h ( {τ}_{k} ) = {α}_{k} δ ( t - {τ}_{k} ) \qquad ( 8 )$$

where, τₖ represents a time delay of when the reflected time domain pulse reached the receiver in comparison to a line-of-sight time domain pulse which was not reflected, and αₖ is a complex value that represents frequency independent attenuation and phase of the reflected time domain pulse.

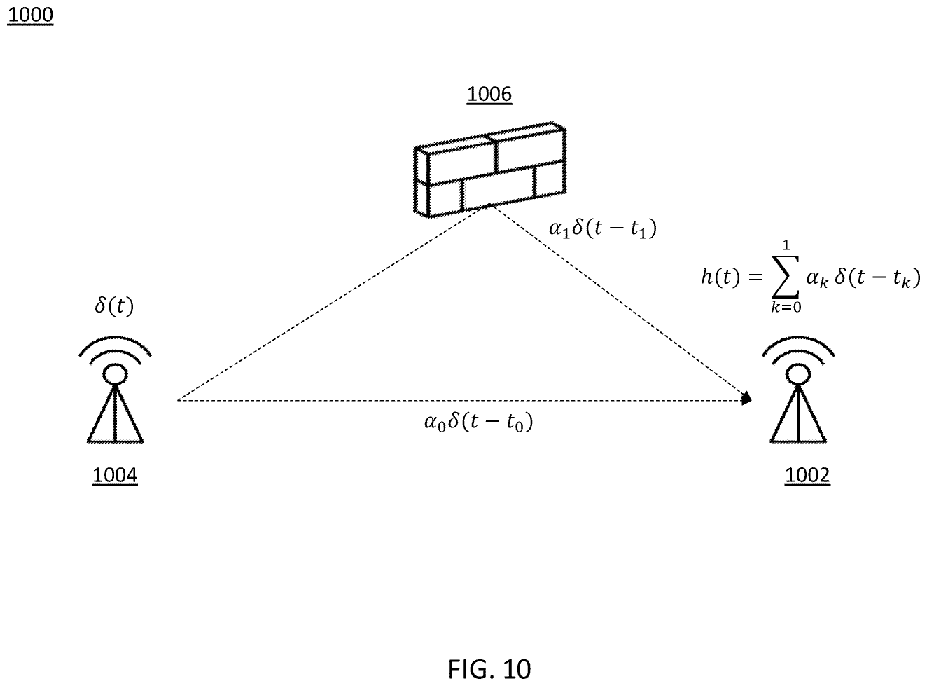

FIG. 10 depicts example representation 1000 of an over-the-air transmission channel, which includes a direct signal path and a single multipath, according to some embodiments. In an implementation, FIG. 10 depicts discrete multipaths of a time domain pulse δ(t) between sensing transmitter 1004 and sensing receiver 1002, according to some embodiments. In FIG. 10, a direct signal path is represented as:

$$h ( {τ}_{0} ) = {α}_{0} δ ( t - {τ}_{0} ) \qquad ( 9 )$$

and a first reflected time domain pulse is represented as:

$$h ( {τ}_{1} ) = {α}_{1} δ ( t - {τ}_{1} ) \qquad ( 10 )$$

The time domain pulse δ(t) undergoes a single reflection (because of reflector 1006) in addition to its line-of-sight path. The line-of-sight time domain pulse transmission time may be incorporated into the complex coefficient α₀ (i.e., τ₀=0). The reflected time domain pulse may experience a delay of τ₁ which represents the amount of time after the line-of-sight time domain pulse is received that the reflected time domain pulse is received.

In an implementation, if a number of discrete time domain pulses in a multipath signal is given by Lₚ, then the received multipath time domain pulse may be represented as:

$$h ( t ) = {\sum }_{k = 0}^{{L}_{p}} {α}_{k} δ ( t - {τ}_{k} ) \qquad ( 11 )$$

The time domain representation of the received multipath signal may be referred to as TD-CRI. In examples, the Equation (11) indicates that each transmission channel may include a number of time domain pulses. A time domain pulse from amongst the time domain pulses may be determined to be a line-of-sight time domain pulse. Further, each time domain pulse may have a frequency independent amplitude and phase component (referred to as the complex coefficient), and all except the line-of-sight time domain pulse may experience a time delay due to reflections, which contributes a frequency dependent component to the complex coefficient.

According to an implementation, a filtered TD-CRI may be created by retaining a portion of the time domain pulses, for example, the time domain pulses that have a minimum amplitude and/or are within a time delay window. Each of the time domain pulses in a steady state channel or a pseudo-steady state channel may have a steady state amplitude (referred to as a base amplitude) and a time delay. Further, the amplitude of the time domain pulses of the filtered TD-CRI at different sensing measurement times may be variable, for example, due to noise or due to a motion of an object.

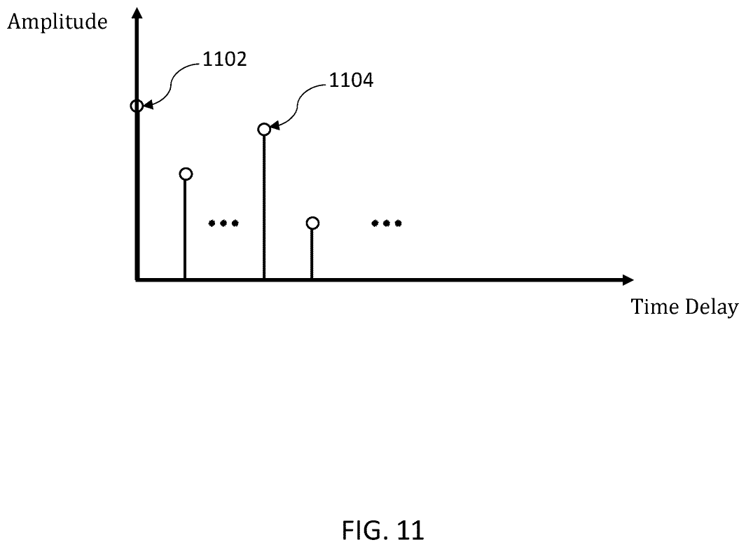

FIG. 11 depicts example representation 1100 of amplitude and time delay of multipath time domain pulses at sensing receiver 502, according to some embodiments. In FIG. 11, reference number “1102” represents a line-of-sight time domain pulse and reference number “1104” represents a time domain pulse of a filtered TD-CRI that has a largest (or maximum) amplitude. In the example of FIG. 11, the time delay of the line-of-sight time domain pulse is referenced to a zero time delay as previously described. In the example of FIG. 11, the line of sight pulse has the greatest amplitude, and the reflected time domain pulses shown have a lower amplitude.

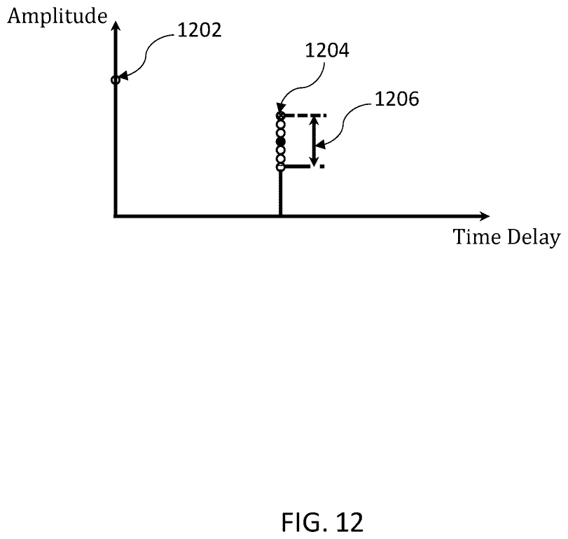

FIG. 12 depicts example representation 1200 of an amplitude of a received multipath signal with a single reflected time domain pulse changed or modulated by a motion of an object, according to some embodiments. In FIG. 12, a line-of-sight time domain pulse (represented by reference number “1202)” and a reflected time domain pulse (represented by reference number “1204)” are shown, where an amplitude of the reflected time domain pulse varies over time due to a motion of an object in the reflected transmission path. Further, reference number “1206” represents the amplitude variation of the reflected time domain pulse over time.

For ease of explanation and understanding, a line-of-sight time domain pulse may hereinafter be referred to as “pulse 0” and the time domain pulse having the largest amplitude may hereinafter be referred to as “pulse k”.

Referring back to FIG. 5, once sensing agent 516 determines the plurality of channel representation information (i.e., the series of time domain pulse sets), sensing agent 516 may identify a signature pulse occurring in the time domain pulse sets. Examples by which sensing agent 516 identifies the signature pulse occurring in the time domain pulse sets are described below. In an implementation, the process of identification of the signature pulse may be described in two phases—Training Phase 1 and Training Phase 2 (collectively referred to as training phase).

### A) Training Phase 1

In an implementation, in Training Phase 1, there is no motion of an object in any reflected transmission path and only a noise of a sensing space is considered. This scenario is considered as a steady state or a pseudo steady state of the sensing space.

In Training Phase 1, amplitude of a time domain pulse (for example, pulse k as described in FIG. 11) is measured at sensing receiver 502 at different sensing measurement times such as t₁, t₂, . . . , t₁, . . . , t_{N}, (i.e., in a series of time domain pulse sets) where the sensing measurement times need not be equidistant. In an implementation, an amplitude of pulse k at sensing measurement time t₁ may be mathematically represented as:

$$A ( {t}_{l} ) \qquad ( 12 )$$

Further, a base amplitude of pulse k over N time samples may be mathematically represented as:

$${A}_{b a s e} = {\sum }_{l = 1}^{N} A ( {t}_{l} ) / N \qquad ( 13 )$$

In an implementation, a waveform amplitude variation of pulse k from base amplitude A_{base} at sensing measurement time t₁ may be mathematically represented as:

$$a ( {t}_{l} ) = A ( {t}_{l} ) - {A}_{b a s e} \qquad ( 14 )$$

In an implementation, a maximum waveform amplitude variation of pulse k among the sensing measurement times (such as t₁, t₂, . . . , t₁, . . . , t_{N}) may be mathematically represented as:

$${a}_{max} = maximum \{ \vert a ( {t}_{1} ) \vert , \vert a ( {t}_{2} ) \vert , … , \vert a ( {t}_{l} ) \vert , … , \vert a ( {t}_{N} ) \vert \} \qquad ( 15 )$$

According to an implementation, a waveform amplitude variation percentage of pulse k may be mathematically represented as:

$$a \% \_noise = {a}_{max} / {A}_{b a s e} \qquad ( 16 )$$

In an implementation, in Training Phase 1, the base amplitude of pulse k A_{base} may be almost stable and the waveform amplitude variation percentage of pulse k a %_noise may be very small. In an example, the waveform amplitude variation percentage of pulse k may be referred to as noise floor.

### B) Training Phase 2

In an implementation, in Training Phase 2, there is a motion of an object in any reflected transmission path (in addition to a noise of a sensing space). In Training Phase 2, as the noise in the sensing space is still present, the base amplitude of pulse k A_{base} is the same as in Training Phase 1.

In an implementation, if amplitude of a time domain pulse (for example, pulse k) is measured at sensing receiver 502 at different sensing measurement times, such as t₁, t₂, . . . , t₁, . . . , t_{N}, then a waveform amplitude variation of pulse k at measurement time t₁ may be mathematically represented as:

$$a ( {t}_{l} ) = A ( {t}_{l} ) - {A}_{b a s e} \qquad ( 17 )$$

Further, a maximum waveform amplitude variation of pulse k among the sensing measurement times, such as t₁, t₂, . . . , t₁, . . . , t_{N} may be mathematically represented as:

$${a}_{max} = maximum \{ \vert a ( {t}_{1} ) \vert , \vert a ( {t}_{2} ) \vert , … , \vert a ( {t}_{l} ) \vert , … , \vert a ( {t}_{N} ) \vert \} \qquad ( 18 )$$

According to an implementation, a waveform amplitude variation percentage of pulse k may be mathematically represented as:

$$a \% \_object = {a}_{max} / {A}_{b a s e} \qquad ( 19 )$$

In an implementation, the waveform amplitude variation percentage of pulse k a %_object caused by the motion of the object (and the noise of the sensing space) may be bigger than the waveform amplitude variation percentage a %_noise caused by the noise only. In examples, when the waveform amplitude variation percentage of pulse k a %_object is bigger than the waveform amplitude variation percentage a %_noise, then waveform amplitude variation of pulse k may be above the noise floor. In an example, the waveform amplitude variation percentage of pulse k a %_object must be bigger than the waveform amplitude variation percentage a %_noise by a minimum threshold for the waveform amplitude variation percentage of pulse k a %_object to be considered a waveform amplitude variation above the noise floor.

According to an implementation, a substantial number of small motions of objects in a sensing space may have waveform frequency signatures. In an example, if a parameter (for example, displacement) of the motion of an object changes along a timeline with a periodic nature at a specific frequency as a waveform (or a sinusoidal form), then it may be considered that the small motion has a waveform frequency signature. For example, a breathing movement of a static human (such as, a human in sleep) may have a waveform frequency signature as displacement of the breathing movement of a human chest changes along a timeline with a roughly periodic nature at a specific frequency as a waveform (which may be a sinusoidal form). In an example, if a small motion of an object with a waveform frequency signature (such as, breathing movement of a static human) is in the path of reflected time domain pulses of a transmitted signal, then it may result into waveform amplitude variations (or modulations) in one or more reflected time domain pulses at the sensing receiver.

In an implementation, waveform amplitude variation(s) (or modulation(s)) of reflected time domain pulse(s) may be sampled at time intervals that correspond with sensing measurement times at a sensing receiver. The time intervals of sensing measurement times at a sensing receiver may be uniform (equidistant) or non-uniform based on the how regularly successful sensing measurements can take place. According to an implementation, an underlying waveform frequency signature of a small motion may be identified from these uniform or non-uniform time intervals at which sensing measurements are made of the reflected time domain pulse(s) of a sensing transmission.

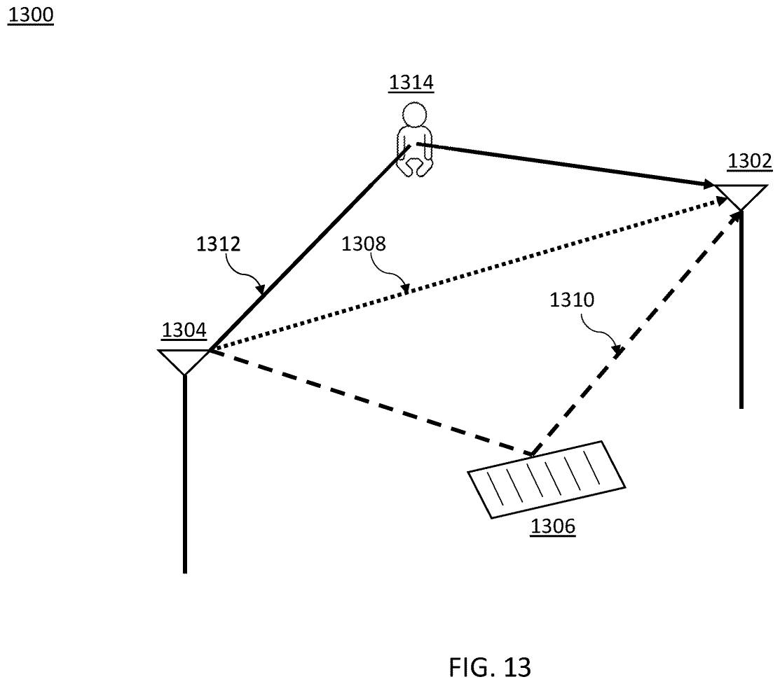

FIG. 13 depicts example representation 1300 of a small motion with a waveform frequency signature in a path of system 500, according to some embodiments. According to an implementation, a wireless signal may propagate between sensing transmitter 1304 and sensing receiver 1302 in a transmission channel and there may be multiple propagation paths resulting in multiple time domain pulses at a sensing receiver. FIG. 13 depicts three propagation paths (i.e., three time domain pulses) between sensing transmitter 1304 and sensing receiver 1302. In an example, the three time domain pulses include a line-of-sight time domain pulse (represented by reference number “1308”), a first reflected time domain pulse (represented by reference number “1310”), and a second reflected time domain pulse (represented by reference number “1312”). As described in FIG. 13, the first reflected time domain pulse is caused due to reflector 1306 in the transmission channel. Further, there is a small motion of object 1314 (for example, breathing movement of a static human) in a path of the second reflected time domain pulse. The small motion of object 1314 may create waveform amplitude variations in the signature pulse which may be the second reflected time domain pulse or may be a different time domain pulse depending on how the reflected signals constructively or destructively combine at the receiver. In an implementation, if a parameter (for example, displacement) of the small motion of object 1314 changes along a timeline with a roughly periodic nature at a specific frequency as a waveform (or a sinusoidal form), then it may be considered that the small motion of object 1314 has a waveform frequency signature.

According to an implementation, TD-CRI may be used to represent a received multipath signal in the time domain. Amongst the received time domain pulses in the multipath signal, one or more of the received time domain pulses may have waveform amplitude variations (or modulations) on top of the base amplitude that are above the noise floor. Such received time domain pulses may be referred to as bobbing pulses. Further, amongst the bobbing pulses with their waveform amplitude variations above the noise floor, one specific bobbing pulse may be a signature pulse if it has the maximum waveform amplitude variation percentage “a %” during the sensing measurement times such as t₁, t₂, . . . , t₁, . . . , t_{N}. In an implementation, the signature pulse may represent a plurality of corresponding pulses, each of the corresponding pulses occurring in a respective one of the time domain pulse sets occurring at each of the sensing measurement times t₁, t₂, . . . , t_{N}. In an implementation, sensing agent 516 may select a received time domain pulse (i.e., a signature pulse) from amongst the bobbing pulses that displays amplitude variations (interchangeably referred to as waveform amplitude variations) across the time domain pulse sets. In implementations, sensing agent 516 may select a received time domain pulse (i.e., a signature pulse) from among the bobbing pulses that has a largest amplitude variation from among the bobbing pulses, across the time domain pulse sets.

In an implementation, the time intervals of sensing measurement times at sensing receiver 502 may be uniform or non-uniform. According to an implementation, the waveform amplitude variations of the signature pulse may represent the waveform frequency signature caused by the small motion (for example, human breath). In an implementation, the amplitude of the signature pulse may have different absolute values at different sensing measurement times and the amplitude variation of the signature pulse may have different values at different sensing measurement times.

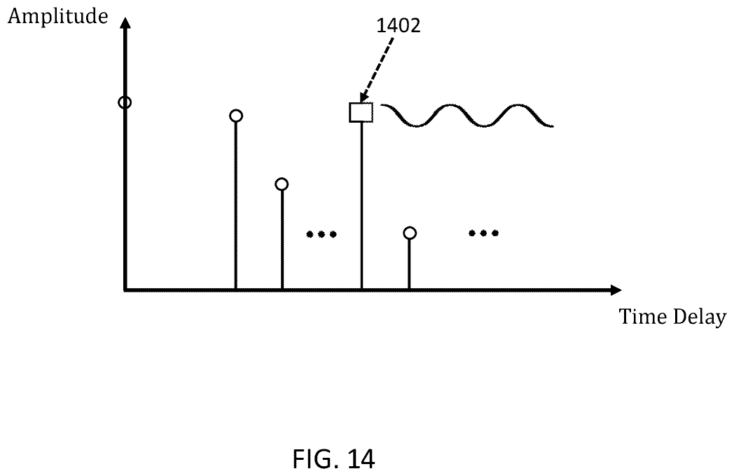

FIG. 14 depicts example representation 1400 of amplitudes of received time domain pulses including a signature pulse, according to some embodiments. In particular, FIG. 14 depicts an amplitude of the signature pulse. In FIG. 14, reference number “1402” represents the signature pulse (also referred to as bobbling pulse k). The signature pulse may have waveform amplitude variations. As illustrated in FIG. 14, the waveform amplitude variations of the signature pulse may vary in a roughly sinusoidal manner over time, however these amplitude variations may be measured at irregular intervals as the measurement times are dependent on when the sensing transmitter is able to make a sensing transmission to the sensing receiver.

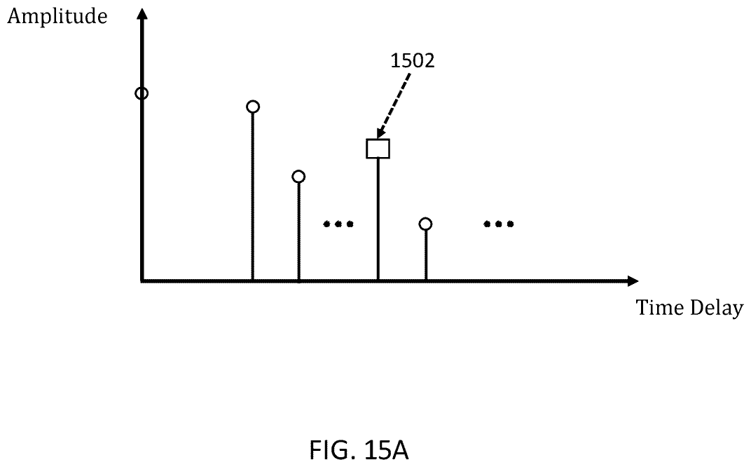

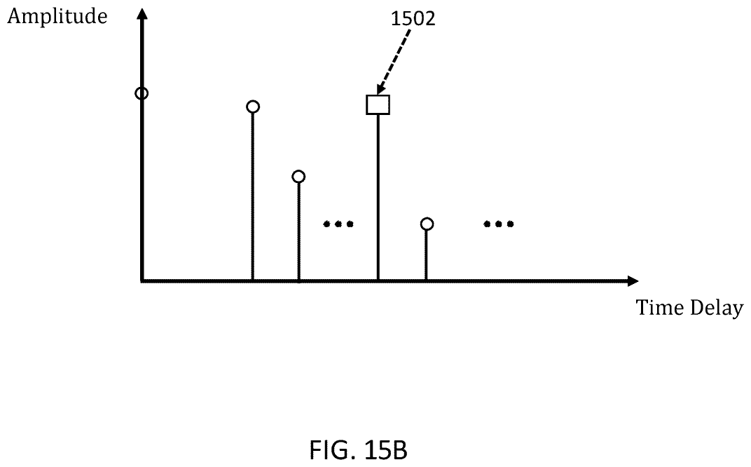

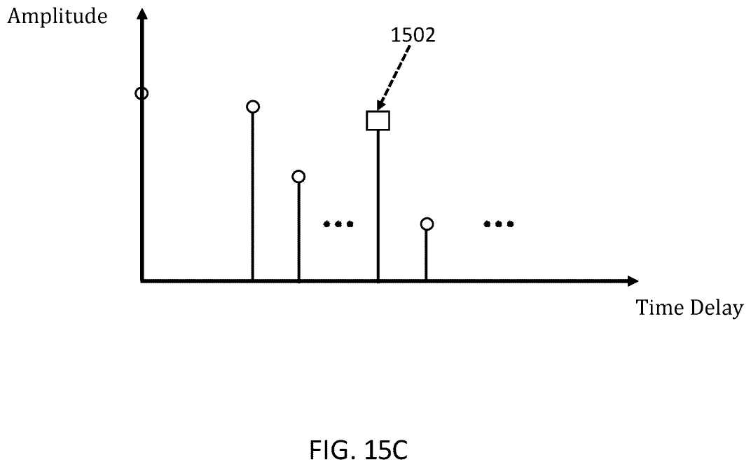

FIG. 15A, FIG. 15B, and FIG. 15C depict example representations of amplitudes of received time domain pulses including a signature pulse at different sensing measurement times, according to some embodiments. In particular, FIG. 15A, FIG. 15B, and FIG. 15C depict example representations of amplitude of a signature pulse (represented by reference number “1502”) at different sensing measurement times, according to some embodiments. In particular, FIG. 15A depicts the amplitude of the signature pulse at sensing measurement time t₁ at sensing receiver 502. FIG. 15B depicts the amplitude of the signature pulse at sensing measurement time t₂ at sensing receiver 502. FIG. 15C depicts the amplitude of the signature pulse at sensing measurement time t_{N} at sensing receiver 502. It can be seen across FIG. 15A, FIG. 15B and FIG. C that the amplitude variation of the signature pulse is captured or sampled at the moment in time that the sensing measurement is made, which depends on the timing of the sensing transmission. Each sensing measurement results in a discrete amplitude measurement of the signature pulse.

Referring back to FIG. 5, after the identification of the signature pulse, sensing agent 516 may store or record a series of amplitudes of the signature pulse in the time domain pulse sets as a function of the sensing measurement times at which the amplitude was recorded. In an implementation, sensing agent 516 may determine the values of the amplitude of the signature pulse (for example, the bobbing pulse k) at different sensing measurement times, such as t₁, t₂, t₁, . . . , t_{N} at Training Phase 1 and Training Phase 2. As previously indicated, the intervals of sensing measurement times at sensing receiver 502 may be uniform or non-uniform based on the successful sensing measurement times. In an implementation, sensing agent 516 may record the series of amplitudes of the signature pulse (i.e., different absolute values of the absolute determined at different sensing measurement times) in the time domain pulse sets together with the measurement times in data storage 518. According to an implementation, sensing agent 516 may record variations in amplitude of the signature pulse (i.e., values representing the difference between the absolute amplitude value of the signature pulse in the time domain pulse sets and the base amplitude) determined at different sensing measurement times together with the measurement times in data storage 518. In an example, the series of amplitudes or amplitude variations of the signature pulse may have a uniform timing between each point in the series. In some examples, the series of amplitudes or amplitude variations of the signature pulse may have a non-uniform timing between each point in the series. Further, the timing between amplitudes or amplitude variations of the series of amplitudes or amplitude variations may be based on timing of at least one of the sensing transmissions and the sensing measurements. In some implementations, sensing agent 516 may record or store the base amplitude “A_{base}”, the amplitude “A(t₁)”, and the waveform amplitude variation “a(t₁)” of the signature pulse at different sensing measurement times in data storage 518.

An example of the base amplitude “A_{base}”, the amplitude “A(t₁)”, and the waveform amplitude variation “a(t₁)” of a signature pulse at different sensing measurement times stored in data storage 518 is illustrates in Table 1 provided below.

TABLE 1
Example of the base amplitude “A_{base}”, the amplitude “A(tₗ)”, and
the waveform amplitude variation “a(tₗ)” of a signature pulse at
different sensing measurement times stored in data storage 518

| l | tₗ | A_{base} | A(tₗ) | a(tₗ) |
|---|---|---|---|---|
| 1 | 0.50 | 10.00 | 10.707107 | 0.707107 |
| 2 | 0.70 | 10.00 | 10.891007 | 0.891007 |
| 3 | 0.80 | 10.00 | 10.951057 | 0.951057 |
| 4 | 1.00 | 10.00 | 11.000000 | 1.000000 |
| 5 | 1.10 | 10.00 | 10.987688 | 0.987688 |
| 6 | 1.20 | 10.00 | 10.951057 | 0.951057 |
| 7 | 1.40 | 10.00 | 10.809017 | 0.809017 |
| 8 | 1.50 | 10.00 | 10.707107 | 0.707107 |
| 9 | 1.80 | 10.00 | 10.309017 | 0.309017 |
| 10 | 1.90 | 10.00 | 10.156434 | 0.156434 |
| 11 | 2.00 | 10.00 | 10.000000 | 0.000000 |
| 12 | 2.10 | 10.00 | 9.843566 | −0.156434 |
| 13 | 2.40 | 10.00 | 9.412215 | −0.587785 |
| 14 | 2.70 | 10.00 | 9.108993 | −0.891007 |
| 15 | 2.90 | 10.00 | 9.012312 | −0.987688 |
| 16 | 3.00 | 10.00 | 9.000000 | −1.000000 |
| 17 | 3.10 | 10.00 | 9.012312 | −0.987688 |
| 18 | 3.20 | 10.00 | 9.048943 | −0.951057 |
| 19 | 3.30 | 10.00 | 9.108993 | −0.891007 |
| 20 | 3.80 | 10.00 | 9.690983 | −0.309017 |
| 21 | 3.90 | 10.00 | 9.843566 | −0.156434 |
| 22 | 4.00 | 10.00 | 10.000000 | 0.000000 |
| 23 | 4.10 | 10.00 | 10.156434 | 0.156434 |
| 24 | 4.20 | 10.00 | 10.309017 | 0.309017 |
| 25 | 4.30 | 10.00 | 10.453990 | 0.453990 |
| 26 | 4.50 | 10.00 | 10.707107 | 0.707107 |
| 27 | 4.70 | 10.00 | 10.891007 | 0.891007 |
| 28 | 4.90 | 10.00 | 10.987688 | 0.987688 |
| 29 | 5.00 | 10.00 | 11.000000 | 1.000000 |
| 30 | 5.20 | 10.00 | 10.951057 | 0.951057 |

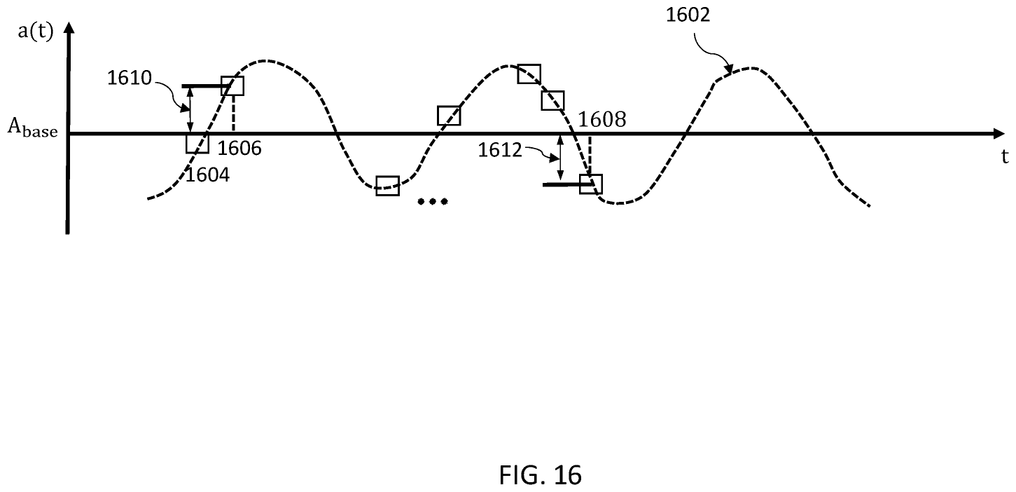

FIG. 16 depicts example representation 1600 of the series of waveform amplitude variations of the signature pulse, according to some embodiments. In FIG. 16, reference number “1602” represents a waveform frequency signature of the small motion of the object. Further, FIG. 16 describes variations in the amplitude of the signature pulse (waveform amplitude variations of the signature pulse from the base amplitude) recorded at different sensing measurement times, such as t₁ (represented by reference number “1604”), t₂ (represented by reference number “1606”), t_{N} (represented by reference number “1608”). Also, reference number “1610” represents waveform amplitude variation of the signature pulse at sensing measurement time t₂, and reference number “1612” represents the waveform amplitude variation of the signature pulse at sensing measurement time t_{N}.

Referring back to FIG. 5, upon identifying the signature pulse occurring in the time domain pulse sets and creating the series of waveform amplitude variations of the signature pulse in the time domain pulse sets, sensing agent 516 may identify a waveform frequency signature of a small motion of an object (for example, breathing movement of a human) occurring in a sensing space corresponding with sensing receiver 502 based on the series of waveform amplitude variations of the signature pulse. In examples, the sensing space may correspond to the transmission pathway between sensing transmitter 504 and sensing receiver 502. In an implementation, sensing agent 516 may identify the waveform frequency signature of the small motion by evaluating the series of waveform amplitude variations s of the signature pulse relative to a reasonable frequency waveform. According to an implementation, sensing agent 516 may create a Fourier basis function from the series of waveform amplitude variations of the signature pulse and the reasonable frequency waveform.

Examples by which sensing agent 516 identifies the waveform frequency signature of the small motion of the object occurring in the sensing space corresponding with sensing receiver 502 are described in greater detail below.

In an implementation, sensing agent 516 may determine a set of reasonable frequencies for the waveform frequency signature of the small motion. In an example, normal human breath rates for an adult at rest may be in a range of 10 breaths to 20 breaths per minute (60 s). If the reasonable range of 10 breaths to 20 breaths per minute (60 s) is taken into consideration, then the physiological reasonable frequency range of human breath may be in a range of 0.166 Hz (10 times/60 s) to 0.333 Hz (20 times/60 s). An example of the set of reasonable frequencies for the waveform frequency signature of human breath is listed in Table 2 (provided below) with a predefined accuracy resolution E (such as E=0.01 Hz).

TABLE 2
Example of the set of reasonable frequencies for
the waveform frequency signature of human breath
with predefined accuracy resolution ε = 0.01 Hz

| fⱼ with ε = 0.01 Hz | Value of fⱼ (Hz) |
|---|---|
| f₁ | 0.16 |
| f₂ | 0.17 |
| f₃ | 0.18 |
| . . . | . . . |
| f₁₅ | 0.30 |
| f₁₆ | 0.31 |
| f₁₇ | 0.32 |
| f₁₈ | 0.33 |

In the above Table 2, the set of reasonable frequencies for the waveform frequency signature of human breath (fⱼ) is defined as (f₁, f₂, f₃, . . . , f₁₅, f₁₆, f₁₇, f₁₈). In an example, the predefined accuracy resolution may provide a way to list the values of the frequency in the reasonable range for the waveform frequency signature for further processing. In an example, the predefined accuracy resolution may have different values (such as E=0.01 Hz, 0.001 Hz, 0.002 Hz, 0.0001 Hz, etc.).

According to an implementation, sensing agent 516 may create the Fourier basis function from the series of waveform amplitude variations of the signature pulse and their associated timestamps, and the set of reasonable frequencies. In an implementation, sensing agent 516 may create the Fourier basis function based on the base amplitude “A_{base}”, the amplitude “A(t₁)”, and the waveform amplitude variation “a(t₁)” of the signature pulse at different sensing measurement times stored in data storage 518 and as shown in Table 1.

In an implementation, the Fourier basis function may be used to determine a frequency value from the set of reasonable frequencies that best represents the waveform frequency signature of the small motion (for example, human breath).

According to an implementation, the Fourier basis function is mathematically expressed below.

$${D ( {f}_{j} ) = {\sum }_{l = 1}^{N} a ( {t}_{l} ) {e}^{- i 2 π {f}_{j} {t}_{l}} \vert}_{{f}_{j}} \qquad ( 20 )$$

where, D(fⱼ) represents the Fourier basis function at frequency fⱼ, a(t₁) represents the waveform amplitude variation of the signature pulse at t₁, t₁ represents the sensing measurement time at sensing receiver 502, and fⱼ represents a frequency from the set of reasonable frequencies.

According to an implementation, sensing agent 516 may be configured to perform multiplication and addition with the Fourier basis function, for example to calculate a strength metric (i.e., ∥D(fⱼ)∥) of specific frequencies (fⱼ) from the set of reasonable frequencies, for the series of sensing measurement times. In an implementation, the calculation of the strength metric of specific frequencies from the set of reasonable frequencies is mathematically expressed below.

$${D ( {f}_{j} ) = {\sum }_{l = 1}^{N} a ( {t}_{l} ) {e}^{- i 2 π {f}_{j} {t}_{l}} \vert}_{{f}_{j}} = {\sum }_{l = 1}^{N} a ( {t}_{l} ) cos ( 2 π {f}_{j} {t}_{l} ) - i {\sum }_{l = 1}^{N} a ( {t}_{l} ) sin ( 2 π {f}_{j} {t}_{l} ) \qquad ( 21 )$$

$$‖ D ( {f}_{j} ) ‖ = {( {\sum }_{l = 1}^{N} a ( {t}_{l} ) cos ( 2 π {f}_{j} {t}_{l} ) )}^{2} + {( {\sum }_{l = 1}^{N} a ( {t}_{l} ) sin ( 2 π {f}_{j} {t}_{l} ) )}^{2} \qquad ( 22 )$$

where, ∥D(fⱼ)∥ represents the strength metric (or simply the strength) of the specific frequency fⱼ from the set of reasonable frequencies for the series of sensing measurement times, and fⱼ represents the specific frequency from the set of reasonable frequencies for the series of sensing measurement times.

An example of calculation of the strength metric for specific frequencies from the set of reasonable frequencies is provided below in Table 3. In examples, the values of t₁ and a(t₁) may be taken from Table 2.

TABLE 3
Example of the calculation of the strength metric (||D(fⱼ)||) of specific
frequencies from the set of reasonable frequencies (for human breath)

| fⱼ | ${{\sum }_{l = 1}^{N}}_{} a ( {t}_{l} ) cos ( 2 π {f}_{j} {t}_{l} )$ | ${{\sum }_{l = 1}^{N}}_{} a ( {t}_{l} ) sin ( 2 π {f}_{j} {t}_{l} )$ | \|\|D(fⱼ)\|\| | Maximum? |
|---|---|---|---|---|
| 0.16 | 10.237245 | 0.282747 | 10.241149 | |
| 0.17 | 11.254427 | 2.061877 | 11.441742 | |
| 0.18 | 11.839317 | 4.188141 | 12.558263 | |
| 0.19 | 11.893975 | 6.538538 | 13.572735 | |
| 0.2 | 11.358166 | 8.964256 | 14.469479 | |
| 0.21 | 10.215740 | 11.302596 | 15.235158 | |
| 0.22 | 8.497206 | 13.390319 | 15.858851 | |
| 0.23 | 6.278255 | 15.077219 | 16.332146 | |
| 0.24 | 3.674349 | 16.238691 | 16.649202 | |
| 0.25 | 0.831848 | 16.786186 | 16.806785 | maximum |
| 0.26 | −2.083541 | 16.674600 | 16.804269 | |
| 0.27 | −4.899932 | 15.905972 | 16.643595 | |
| 0.28 | −7.452914 | 14.529172 | 16.329199 | |
| 0.29 | −9.598444 | 12.635651 | 15.867886 | |
| 0.3 | −11.223891 | 10.351661 | 15.268681 | |
| 0.31 | −12.256252 | 7.827679 | 14.542636 | |
| 0.32 | −12.666902 | 5.226009 | 13.702612 | |
| 0.33 | −12.472501 | 2.707692 | 12.763028 | |

According to an implementation, sensing agent 516 identify a maximum value of the strength metric as being equal to the maximum ∥D(fⱼ)∥. Further, sensing agent 516 may identify a specific reasonable frequency (fₘ) of the maximum ∥D(fₘ)∥ as a discovered waveform frequency signature of the small motion. In an example, if ∥D(0.250)∥ is the maximum value among all the values of ∥D(fⱼ)∥ as described in Table 3 for the human breath case, then fₘ=0.250 Hz (15 breaths per minute) is the waveform frequency signature of the small motion (for example, human breath).

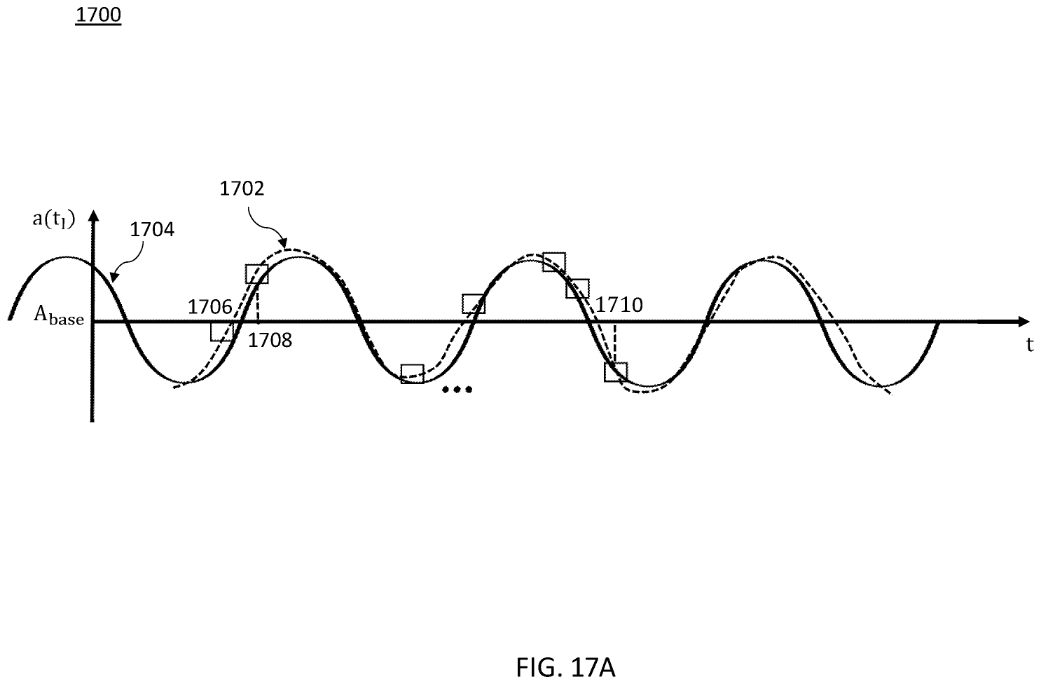

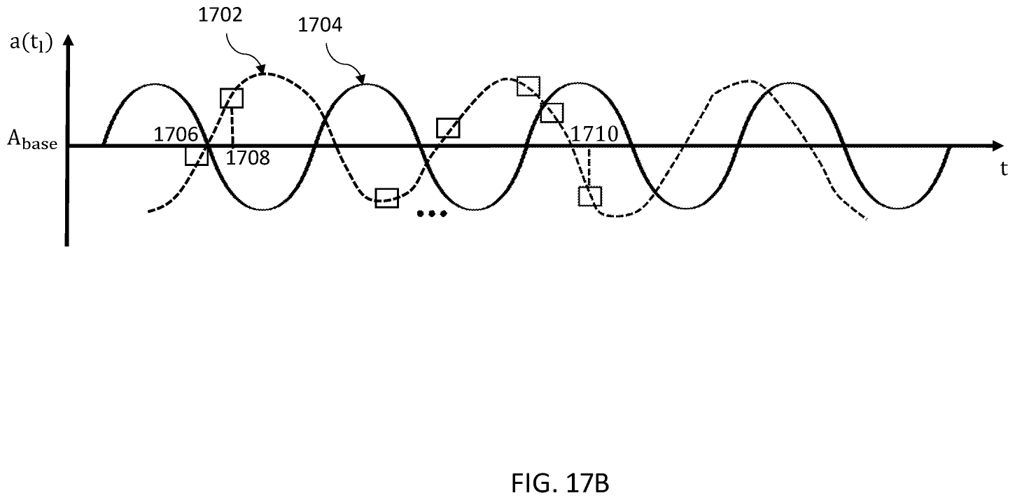

FIG. 17A depicts an example of a reasonable frequency (fₘ) that is well aligned with a frequency of the waveform amplitude variations of the signature pulse, according to some embodiments. In FIG. 17A, reference number “1702” represents waveform frequency signature of the small motion of the object, and reference number “1704” represents reasonable frequency waveform for reasonable frequency (fₘ). Further, FIG. 17A describes variations in the amplitude of the signature pulse recorded at different sensing measurement times, such as t₁ (represented by reference number “1706”), t₂ (represented by reference number “1708”), . . . , t_{N} (represented by reference number “1710”). As described in FIG. 17A, the reasonable frequency (fₘ) is well aligned with the frequency of the waveform amplitude variation of the signature pulse.

FIG. 17B depicts an example of a reasonable frequency (fₙ) that is not well aligned with a frequency of the waveform amplitude variation of the signature pulse, according to some embodiments. In FIG. 17B, reference number “1702” represents waveform frequency signature of the small motion of the object, and reference number “1704” represents reasonable frequency waveform for reasonable frequency (fₙ). Further, FIG. 17B describes variations in the amplitude of the signature pulse recorded at different sensing measurement times, such as t₁ (represented by reference number “1706”), t₂ (represented by reference number “1708”), . . . , t_{N} (represented by reference number “1710”). As described in FIG. 17B, the reasonable frequency (fₙ) is not well aligned with the frequency of the waveform amplitude variation of the signature pulse.

FIG. 18 depicts flowchart 1800 for identification of a waveform frequency signature of a small motion occurring in a sensing space, according to some embodiments.

In a brief overview of an implementation of flowchart 1800, at step 1802, a series of time domain pulse sets determined from a series of sensing measurements based on a series of sensing transmissions transmitted by sensing transmitter 504 and received by a networked device operating as a sensing receiver over a time interval may be obtained. At step 1804, a signature pulse occurring in the time domain pulse sets is identified. At step 1806, a series of amplitudes of the signature pulse in the time domain pulse sets is recorded. At step 1808, a waveform frequency signature of a small motion occurring in a sensing space corresponding with the networked device is identified based on the series of amplitudes of the signature pulse.

Step 1802 includes obtaining a series of time domain pulse sets determined from a series of sensing measurements based on a series of sensing transmissions transmitted by sensing transmitter 504 and received by a networked device over a time interval. In an implementation, the networked device may operate as sensing receiver 502. According to an implementation, sensing receiver 502 may be configured to obtain the series of time domain pulse sets determined from the series of sensing measurements based on the series of sensing transmissions transmitted by sensing transmitter 504 and received by sensing receiver 502 over the time interval.

Step 1804 includes identifying a signature pulse occurring in the time domain pulse sets. According to an implementation, networked device operating as sensing receiver 502 may be configured to identify the signature pulse occurring in the time domain pulse sets. In an implementation, the signature pulse may represent a plurality of corresponding pulses, each of the corresponding pulses occurring in a respective one of the time domain pulse sets. Further, in an implementation, networked device operating as sensing receiver 502 may identify the signature pulse based on selecting the signature pulse from among a plurality of bobbing pulses displaying amplitude variations in the time domain pulse sets. In implementations, networked device operating as sensing receiver 502 may identify the signature pulse based on selecting the bobbing pulse having a largest amplitude variation from among the plurality of bobbing pulses.

Step 1806 includes recording a series of amplitudes of the signature pulse in the time domain pulse sets. According to an implementation, networked device operating as sensing receiver 502 may be configured to record the series of amplitudes of the signature pulse in the time domain pulse sets. In an example, the series of amplitudes of the signature pulse may have a uniform timing between amplitudes. In some example, the series of amplitudes of the signature pulse may have a non-uniform timing between amplitudes. In an example, timing between amplitudes of the series of amplitudes may be based on timing of at least one of the sensing transmissions and the sensing measurements. In an implementation, networked device operating as sensing receiver 502 may record variations in amplitude of the signature pulse. Variations in amplitude of the signature pulse may be describes as waveform amplitude variations which represent the amplitude difference from a base amplitude of the time domain pulse, in some embodiments.

Step 1808 includes identifying a waveform frequency signature of a small motion occurring in a sensing space corresponding with the networked device based on the series of amplitudes of the signature pulse. According to an implementation, networked device operating as sensing receiver 502 may be configured to identify the waveform frequency signature of the small motion occurring in the sensing space corresponding with sensing receiver 502 (i.e., the networked device) based on the series of amplitudes of the signature pulse. In an implementation, networked device operating as sensing receiver 502 may be configured to identify the waveform frequency signature based on evaluating the series of amplitudes of the signature pulse relative to a reasonable frequency waveform. In examples, evaluating the series of amplitudes of the signature pulse comprises evaluating the series of waveform amplitude variations of the signature pulse. According to an implementation, networked device operating as sensing receiver 502 may create a Fourier basis function from one of the series of amplitudes or the series of waveform amplitude variations of the signature pulse and the reasonable frequency waveform. In examples, evaluating the series of amplitudes or the series of waveform amplitude variations of the signature pulse includes creating a Fourier basis function from the series of amplitudes or the series of waveform amplitude variations of the signature pulse and a reasonable frequency waveform based on a reasonable frequency of one or more possible reasonable frequencies. In examples, the sensing space corresponds to the transmission pathway between a sensing transmitter 504 and the networked device operating as a sensing receiver 502. In examples, the sensing space corresponds to the transmission pathway between the networked device operating as a sensing receiver 502 and a sensing transmitter 504.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1. A method for Wi-Fi sensing carried out by a sensing receiver including at least one processor configured to execute instructions, the method comprising:
obtaining, by the at least one processor, a series of sensing measurements based on a series of sensing transmissions received by the sensing receiver over a time interval, wherein a sensing measurement comprises a time domain pulse set, wherein each time domain pulse set is identified according to a signature pulse of the time domain pulse set;
obtaining, by the at least one processor, a set of amplitudes for each time domain pulse set of the series of time domain pulse sets;
identifying a motion occurring in a sensing space based on the set of amplitudes for each time domain pulse set of the series of time domain pulse sets received over the time interval.

2-11. (canceled)

12. A system for motion sensing, comprising:
a networked device configured to operate as a sensing receiver, the networked device including at least one processor configured to:
obtaining, by the at least one processor, a series of sensing measurements based on a series of sensing transmissions received by the sensing receiver over a time interval, wherein a sensing measurement comprises a time domain pulse set, wherein each time domain pulse set is identified according to a signature pulse of the time domain pulse set;
obtaining, by the at least one processor, a set of amplitudes for each time domain pulse set of the series of time domain pulse sets;
identifying a motion occurring in a sensing space based on the set of amplitudes for each time domain pulse set of the series of time domain pulse sets received over the time interval.

13-22. (canceled)

23. The method of claim 1, wherein the signature pulse of the time domain pulse set is the time domain pulse with a largest amplitude.

24. The method of claim 1, wherein the signature pulse has an amplitude that exceeds a minimum amplitude threshold.

25. The method of claim 1, wherein the signature pulse is selected from among a plurality of pulses displaying amplitude variations of a respective time domain pulse set.

26. The method of claim 1, wherein timing between time domain pulses of the time domain pulse set is based on timing of either or both of the series of sensing transmissions and the series of sensing measurements.

27. The method of claim 1, wherein the sensing space further corresponds to a transmission pathway between the sensing receiver and the sensing transmitter.

28. The method of claim 1, wherein the time domain pulses of the time domain pulse set are selected according to the signature pulse.

29. The method of claim 28, wherein the time domain pulses of the time domain pulse set are selected according to uniform timing differences with the signature pulse.

30. The system of claim 12, wherein the signature pulse of the time domain pulse set is the time domain pulse with a largest amplitude.

31. The system of claim 12, wherein the signature pulse has an amplitude that exceeds a minimum amplitude threshold.

32. The system of claim 12, wherein the signature pulse is selected from among a plurality of pulses displaying amplitude variations of a respective time domain pulse set.

33. The system of claim 12, wherein timing between time domain pulses of the time domain pulse set is based on timing of either or both of the series of sensing transmissions and the series of sensing measurements.

34. The system of claim 12, wherein the sensing space further corresponds to a transmission pathway between the networked device and the sensing transmitter.

35. The system of claim 12, wherein the time domain pulses of the time domain pulse set are selected according to the signature pulse.

36. The system of claim 35, wherein the time domain pulses of the time domain pulse set are selected according to uniform timing differences with the signature pulse.
